(19) United States
(12) Patent Application Publication
(10) Pub. No.: US 2015/0060287 A1
(43) Pub. Date: Mar. 5, 2015

(54) Fluid Conditioning & Ionizing System

(71) Applicant: Mark Sherman, Phoenix, AZ (US)

(72) Inventor: Mark Sherman, Phoenix, AZ (US)

(21) Appl. No.: 14/017,309

(22) Filed: Sep. 4, 2013

(51) Int. Cl. C02F 1/46

(52) U.S. Cl. CPC C02F 1/4606; C02F 2201/46105
USPC 204/670; 204/660

(57) ABSTRACT

An apparatus includes an electrode body, and an electrically conductive fastener which includes titanium, wherein the electrically conductive fastener is threadingly engaged with the electrode body to form a titanium-metal interlace to conduct current. The apparatus includes an electrically conductive coil through which the electrode body and electrically conductive fastener extend, and a strainer basket fastened to the electrode body with an electrically insulative fastener.

### BACKGROUND OF THE INVENTION

1. Field of the Invention

This invention relates generally to conditioning a conductive fluid with an ionizing system.

2. Description of the Related Art

There are many systems for conditioning a conductive fluid with an ionizing system. The conductive fluid can be of many different types, such as water or oil. Examples of such ionizing systems are disclosed in U.S. Pat. Nos. 5,059,296 and 5,085,753, as well as U.S. Design Pat. Nos. D318,091 and D318,094, the contents of each of which are incorporated by reference as though fully set forth herein. These systems involve removing organic material from water so that it is useful for a particular purpose, such as drinking and swimming. More information regarding the removal of organic material from a fluid can be found in U.S. Pat. Nos. 3,925,205, 3,926,802, 3,948,632, 4,098,602, 4,199,451 4,282,104, 5,059,296, 5,085,753, 5,332,511, 5,364,512, 5,373,025, 5,541,150, 6,387,415 and 6,824,794, as well as in International Application No. PCT/US2005/033064.

A typical ionizing system, such as the water purifiers of U.S. Pat. Nos. 5,059,296 and 5,085,753, includes an anode and cathode carried by a buoyant housing, wherein the anode and cathode extend through the conductive fluid. The anode is fastened to the buoyant housing by using a fastener, and the cathode is spaced apart from the anode. The material of the anode can be of many different types, such as copper, brass, nickel, silver and/or stainless steel, as well as alloys thereof. The cathode can be of many different types. In the embodiments of U.S. Pat. Nos. 5,059,296 and 5,085,753, the cathode is a spring.

The anode and cathode are extended through the conductive fluid. Ions are released by the anode into the conductive fluid in response to establishing a potential difference between the anode (+) and cathode (−). The released ions condition the conductive fluid, such as by preventing the growth of algae or bacteria.

As can be appreciated, the dimensions of the anode decrease in response to releasing ions into the conductive fluid. Further, corrosion of the anode, in response to being ionized, makes it more difficult to unfasten the fastener from the anode. It is desirable to be able to unfasten the fastener from the anode so the anode can be replaced. Hence, it is useful to include a material with the ionizing system which experiences less corrosion, so the anode experiences a longer life so the anode has to be replaced less often.

### BRIEF SUMMARY OF THE INVENTION

The present invention is directed to an ionizing system which includes a material which experiences less corrosion in response to a current flow therethrough in the presence of a fluid, such as water. The invention will be best understood from the following description when read in conjunction with the accompanying drawings. The novel features of the invention are set forth with particularity in the appended claims.

### BRIEF DESCRIPTION OF THE DRAWINGS

It should be noted that like reference characters are used throughout the several views of the drawings.

FIG. 1 is a schematic view of an embodiment of an electrode assembly.

FIGS. 2a and 2b are side and cut-away side views, respectively, of one embodiment of the electrode assembly of FIG. 1.

FIG. 2c is a cross-sectional view of the electrode assembly of FIG. 2a taken along a cut-line 2c-2c, wherein the cross-sectional shape of the electrode assembly is circular.

FIG. 2d is a cross-sectional view of the electrode assembly of FIG. 2a taken along the cut-line 2c-2c, wherein the cross-sectional shape of the electrode assembly is elliptical.

FIG. 2e is a cross-sectional view of the electrode assembly of FIG. 2a taken along the cut-line 2c-2c, wherein the cross-sectional shape of the electrode assembly is square.

FIG. 2f is a cross-sectional view of the electrode assembly of FIG. 2a taken along the cut-line 2c-2c, wherein the cross-sectional shape of the electrode assembly is rectangular.

FIG. 2g is a cross-sectional view of the electrode assembly of FIG. 2a taken along the cut-line 2c-2c, wherein the cross-sectional shape of the electrode assembly is triangular.

FIGS. 3a and 3b are opposed perspective views of an electrode body of the electrode assembly of FIG. 1.

FIG. 3c is a side view of an electrically conductive fastener of the electrode assemblies of FIG. 1.

FIGS. 4a and 4b are side and cut-away side views, respectively, of the electrode assembly of FIG. 1, which includes an insulative bushing.

FIG. 5a is a perspective view of the insulative bushing of FIGS. 4a and 4b.

FIG. 5b is an end view of the insulative bushing of FIGS. 4a and 4b.

FIG. 5c is cut-away side view of the insulative bushing of FIGS. 4a and 4b.

FIGS. 6a and 6b are side and cut-away side views, respectively, of the electrode assembly of FIGS. 4a and 4b, which includes an insulative fastener.

FIGS. 7a and 7b are front and side views, respectively, of the insulative fastener of FIGS. 6a and 6b.

FIGS. 7c and 7d are top and bottom views, respectively, of the insulative fastener of FIGS. 6a and 6b.

FIGS. 8a and 8b are cut-away side views of different embodiments of electrode assemblies.

FIG. 9a is a partial cut-away side view of a strainer assembly, which includes the electrode assembly of FIGS. 6a and 6b.

FIG. 9b is a perspective view of a coil of the strainer assembly of FIG. 9a.

FIG. 9c is a perspective view of a strainer basket of the strainer assembly of FIG. 9a.

FIGS. 9d and 9e are side perspective and bottom perspective views, respectively, of the coil of FIG. 9b.

FIG. 9f is a perspective view of a clamp included with the strainer assembly of FIG. 9a.

FIGS. 9g and 9h are front views of the clamp of FIG. 9f in uncrimped and crimped conditions, respectively.

FIG. 10 is a schematic diagram of an ionization circuit, which includes the electrode assembly of FIG. 1.

FIGS. 11a and 11b are perspective and side views, respectively, of one embodiment of a purifier system.

FIG. 11c is a cut-away perspective view of a purifier system housing of purifier system taken along a cut-line 11c-11c of FIG. 11a.

FIGS. 11d and 11e are cut-away perspective and side views, respectively, of purifier system taken along a cut-line 11d-11d of FIG. 11a.

FIG. 11f is a top view of a portion of the purifier system of FIGS. 11a and 11b.

FIGS. 11g and 11h are perspective and side views, respectively, of the portion of the purifier system of FIG. 11f.

FIGS. 11i and 11j are perspective and side views, respectively, of the portion of the purifier system of FIG. 11f with the conductive coil of FIG. 9b.

FIG. 11k is a side perspective view of the purifier system of FIGS. 11a and 11b with the strainer basket removed.

FIG. 11l is a top view of one embodiment of a solar panel array, which can be included with the purifier system of FIGS. 11a and 11b.

FIGS. 11m and 11n are top and bottom perspective views, respectively, of the solar panel array of FIG. 11l.

FIG. 12 is a schematic diagram of an ionization circuit, which includes the electrode assembly of FIG. 1.

### DETAILED DESCRIPTION OF THE INVENTION

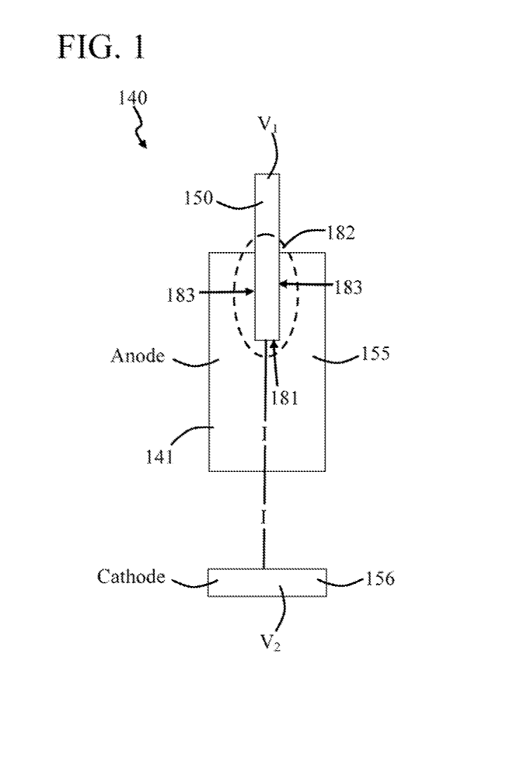

FIG. 1 is a schematic diagram of an embodiment of an electrode assembly 140. In this embodiment, electrode assembly 140 includes an anode 155 and cathode 156 spaced apart from each other, wherein anode 155 includes an electrode body 141. Electrode assembly 140 includes a conductive fastener 150 engaged with electrode body 141 proximate to a region 182. Region 182 includes interfaces 181 and 183, which are established between the engagement of fastener 150 and electrode body 141. In particular, the outer periphery of fastener 150 is engaged with the inner periphery of electrode body 141, so that interfaces 181 and 183 are adjacent to a portion of the outer periphery of fastener 150 and a portion of the inner periphery of electrode body 141. In some embodiments, the distal end of fastener 150 does not engage electrode body 141 so that interface 183 is established and interface 181 is not established. In these embodiments, an electrical current I flows through interface 183 and the electrical current I does not flow through interface 181.

It should be noted that electrically conductive fastener 150 typically includes threads so that it is a threaded fastener. In these threaded fastener embodiments, interface 183 corresponds to a threaded interface. In other embodiments, electrically conductive fastener 150 is a non-threaded fastener, such as a pin, so that interface 183 corresponds to a non-threaded interface. In some embodiments, electrically conductive fastener 150 includes an outer coating layer, which is corrosion resistant. As discussed in more detail below, the outer coating layer can include many different types of materials, such as titanium, platinum, gold and silver. Fastener 150 is repeatably moveable between fastened and unfastened conditions with electrode body 141.

The outer coating layer is positioned adjacent to the interface between fastener 150 and electrode body 141. Hence, interfaces 181 and 183 are titanium interfaces when the outer coating layer includes titanium.

In this embodiment, anode 155 and cathode 156 are spaced apart from each other so that the electrical current I can flow between them. In particular, conductive fastener 150 and electrode body 141 are spaced apart from cathode 156. In this embodiment, the electrical current I flows through the portions of fastener 150 and electrode body 141 that are engaged together proximate to region 182. In particular, the electrical current I flows through interfaces 181 and 183.

The electrical current I flows between fastener 150 and electrode body 141 in response to establishing a potential difference between anode 155 and cathode 156. Further, the electrical current I flows between electrode body 141 and cathode 156 in response to establishing the potential difference between anode 155 and cathode 156. The potential difference can be established in many different ways, such as by providing a potential V₁ to fastener 150 and a potential V₂ to cathode 156, wherein the potential difference is the difference between potentials V₁ and V₂. The electrical current I increases and decreases in response to increasing and decreasing, respectively, the potential difference.

It should be noted that electrode assembly 140 is immersed in a conductive fluid during operation. In particular, anode 155 and cathode 156 are in contact with the conductive fluid. Portions of fastener 150 and electrode body 141 are in contact with the conductive fluid, so that the electrical current I flows through the conductive fluid between anode 155 and cathode 156. The conductive fluid can be of many different types, such as water and/or oil.

It should also be noted that the potential difference can have positive and negative voltage values. For example, in some situations, potential V₁ is greater than potential V₂ so that anode 155 is positive and cathode 156 is negative. Ions are released by anode 155 into the conductive fluid in response to potential V₁ being greater than potential V₂.

In other situations, potential V₁ is less than potential V₂ so that anode 155 is negative and cathode 156 is positive. Ions are restricted from being released by anode 155 into the conductive fluid in response to potential V₁ being less than potential V₂. It is useful to have potential V₁ be less than potential V₂ to clean anode 155.

Electrode body 141 can include many different types of conductive materials, such as stainless steel, titanium, copper and silver, nickel, or alloys thereof. In some embodiments, electrode body 141 includes an alloy of a conductive material, such as an alloy of steel, stainless steel, titanium, copper and/or silver. There are many different types of stainless steel that can be included in electrode body 141, such as Type 306 Stainless Steel and Type 316 Stainless Steel. The types of stainless steel are currently graded by SAE International. More information regarding conductive materials of electrode body 141 can be found in the above-identified U.S. Pat. Nos. 5,059,296 and 5,085,753.

In some embodiments, electrode body 141 includes an alloy of conductive material, such as an alloy of copper and silver. Further, as mentioned above, the material of electrode body 141 is ionized in response to flowing the electrical current I therethrough. It should be noted that the corrosion rate of the material of electrode body 141 increases proximate to region 182. The corrosion rate of the material of electrode body 141 increases proximate to region 182 because fastener 150 and electrode body 141 are engaged together proximate to region 182.

Ions are released by 155 anode into the conductive fluid in response to establishing a potential difference between anode 155 and cathode 156. The released ions condition the conductive fluid, such as by preventing the growth of algae or bacteria. It is desirable to condition the conductive fluid for reasons discussed in more detail above. The conditioning process involves ionizing anode 155 into the conductive fluid. More information regarding conditioning the fluid through ionization is provided in some of the above-identified patents and patent applications.

It should be noted that the material of electrode body 141 is ionized in response to a positive electrical current I flowing therethrough. The material of electrode body 141 is ionized so that portions of it are removed from electrode body 141 and become part of the fluid solution. The removal of material is often referred to as corrosion, and the rate at which the material is removed is often referred to as the corrosion rate. As can be appreciated, the dimensions of electrode body 141 decrease in response to its material being ionized. Hence, electrode body 141 is sometimes referred to as a sacrificial electrode. Electrode body 141 is normally removed from electrode assembly 140 and replaced with a new electrode when depleted.

The material of conductive fastener 150 can be ionized in response to flowing the electrical current I therethrough, with a conductive fluid present, such as water. The material of conductive fastener 150 can be ionized so that portions of it are removed from conductive fastener 150 thereby reducing the fastener mass and dimension. As can be appreciated, the dimensions of conductive fastener 150 decrease in response to its material being ionized.

In this embodiment, fastener 150 includes a material that is less susceptible to corrosion. In some embodiments, fastener 150 includes a material that is less susceptible to corrosion than steel. In some embodiments, fastener 150 includes a material that is less susceptible to corrosion than brass.

In this embodiment, conductive fastener 150 includes titanium. In some embodiments, electrically conductive fastener 150 includes a titanium alloy. The American Society for Testing and Materials (ASTM) provides technical standards for different compositions of titanium and titanium alloys in an annularly published book entitled “Annual Book of ASTM Standards”. For titanium, there are currently thirty-eight (38) grades of titanium. Material of Grades 1-4 include unalloyed titanium, which are useful for corrosion resistant applications. Several of the other material grades, such as Grades 5, 7, 7H, 11, 16 and 17, are enhanced corrosion resistance materials which include titanium and palladium. The amount of palladium of the material can be of many different values. In some embodiments, the material of conductive fastener 150 includes an amount of palladium between 0.1% to about 0.25%, and the remainder of the material is titanium. In some embodiments, the material of conductive fastener 150 includes an amount of palladium between 0.03% to 0.1%, and the remainder of the material is titanium.

In some embodiments, other material, such as aluminum, vanadium, iron, steel, stainless steel and/or oxygen is included with the material of electrically conductive fastener 150. The material of electrically conductive fastener 150 can include many different types of stainless steel, such as Type 306 Stainless Steel and Type 316 Stainless Steel. The amount of these other materials can have many different values. In some embodiments, the material of electrically conductive fastener 150 includes less than 6.1% aluminum, and the remainder of the material is titanium. In some embodiments, the material of conductive fastener 150 includes less than 4.1% vanadium, and the remainder of the material is titanium. In some embodiments, the material of conductive fastener 150 includes less than 0.3% iron, and the remainder of the material is titanium. In some embodiments, the material of conductive fastener 150 includes less than 0.3% oxygen, and the remainder of the material is titanium. In some embodiments, the material of conductive fastener 150 includes less than 6.1% aluminum, less than 4% vanadium, less than 0.3% iron and less than 0.3% oxygen, and the remainder of the material is titanium. In any of the embodiments, the material of conductive fastener 150 can include palladium, if desired.

It should be noted that it is desirable to have the electrical current I flow through the metal of conductive fastener 150. In some embodiments, the titanium is positioned proximate to the outer periphery of conductive fastener 150. It is desirable to have the titanium positioned proximate to the outer periphery of conductive fastener 150 because the electrical current I flows proximate to the periphery of conductive fastener 150.

The amount of titanium of conductive fastener 150 can be of many different values. In some embodiments, conductive fastener 150 includes between ninety-five percent (95%) titanium to one-hundred percent (100%) titanium. In some embodiments, conductive fastener 150 includes between ninety-three percent (93%) titanium to one-hundred percent (100%) titanium. In some embodiments, conductive fastener 150 includes between ninety percent (90%) titanium to one-hundred percent (100%) titanium. In some embodiments, conductive fastener 150 includes between eighty-five percent (85%) titanium to one-hundred percent (100%) titanium. In some embodiments, conductive fastener 150 includes more than fifty percent (50%) titanium.

In general, the amount of titanium of conductive fastener 150 is chosen to reduce the corrosion of the material of fastener 150 by a desired amount. The amount of titanium of conductive fastener 150 depends on many different factors, such as the type of fluid, the value of the electrical current I and the potential difference between V₁ and V₂. In general, the amount of titanium chosen increases in response to increasing the electrical current I and the potential difference between V₁ and V₂. Further, the amount of titanium chosen decreases in response to decreasing the electrical current I and the potential difference between V₁ and V₂. The amount of titanium of fastener 150 can also depend on the material of electrode body 141, as will be discussed in more detail presently.

In some embodiments, fastener 150 is a titanium fastener. In some embodiments, fastener 150 consists of titanium and, in other embodiments, fastener 150 consists essentially of titanium. In some embodiments, fastener 150 includes titanium of Grades 1, 2, 3 or 4 of the ASTM standards. In another example, fastener 150 includes more than 95% titanium.

In other embodiments, fastener 150 includes an outer titanium coating layer. The outer titanium coating layer is typically formed on conductive fastener shaft 152. The outer titanium coating layer can be formed in many different ways, such as by using electroplating. In one embodiment, conductive fastener shaft 152 includes stainless steel, and the outer titanium coating layer is formed thereon. In another embodiment, conductive fastener shaft 152 includes Type 306 Stainless Steel, and the outer titanium coating layer is formed thereon. In another embodiment, conductive fastener shaft 152 includes Type 316 Stainless Steel, and the outer titanium coating layer is formed thereon. In some embodiments, conductive fastener shaft 152 includes a non-electrically conductive ceramic material, and the outer titanium coating layer is formed thereon.

In some embodiments, the outer titanium coating layer consists of titanium and, in other embodiments, the outer titanium coating layer consists essentially of titanium. In some embodiments, the outer titanium coating layer includes titanium of Grades 1, 2, 3 or 4 of the ASTM standards. In another example, the outer titanium coating layer includes more than 95% titanium.

In some embodiments, fastener 150 is a platinum fastener. In some embodiments, fastener 150 consists of platinum and, in other embodiments, fastener 150 consists essentially of platinum. In one example, fastener 150 includes platinum of Grades 99.5, 99.90, 99.95, 99.99 and/or 99.9995 of the ASTM standards. In another example, fastener 150 includes more than 95% platinum.

In other embodiments, fastener 150 includes an outer platinum coating layer. The outer platinum coating layer is typically formed on conductive fastener shaft 152. The outer platinum coating layer can be formed in many different ways, such as by using electroplating. In one embodiment, conductive fastener shaft 152 includes stainless steel, and the outer platinum coating layer is formed thereon. In another embodiment, conductive fastener shaft 152 includes Type 306 Stainless Steel, and the outer platinum coating layer is formed thereon. In another embodiment, conductive fastener shaft 152 includes Type 316 Stainless Steel, and the outer platinum coating layer is formed thereon.

In some embodiments, the outer platinum coating layer consists of platinum and, in other embodiments, the outer platinum coating layer consists essentially of platinum. In some embodiments, the outer platinum coating layer includes inure than 95% platinum.

In some embodiments, fastener 150 is a gold fastener. In some embodiments, fastener 150 consists of gold and, in other embodiments, fastener 150 consists essentially of gold. In one example, fastener 150 includes gold of Grades 99.5, 99.90, 99.95, 99.99 and/or 99.9995 of the ASTM standards. In another example, fastener 150 includes more than 95% gold.

In other embodiments, fastener 150 includes an outer gold coating layer. The outer gold coating layer is typically formed on conductive fastener shaft 152. The outer gold coating layer can be formed in many different ways, such as by using electroplating. In one embodiment, conductive fastener shaft 152 includes stainless steel, and the outer gold coating layer is formed thereon. In another embodiment, conductive fastener shaft 152 includes Type 306 Stainless Steel, and the outer gold coating layer is formed thereon. In another embodiment, conductive fastener shaft 152 includes Type 316 Stainless Steel, and the outer gold coating layer is formed thereon.

In some embodiments, the outer gold coating layer consists of gold and, in other embodiments, the outer gold coating layer consists essentially of gold. In some embodiments, the outer gold coating layer includes more than 95% gold.

In some embodiments, fastener 150 is a silver fastener. In some embodiments, fastener 150 consists of silver and, in other embodiments, fastener 150 consists essentially of silver. In one example, fastener 150 includes silver of Grades 99.5, 99.90, 99.95, 99.99 and/or 99.9995 of the ASTM standards. In another example, fastener 150 includes more than 95% silver.

In other embodiments, fastener 150 includes an outer silver coating layer. The outer silver coating layer is typically formed on conductive fastener shaft 152. The outer silver coating layer can be formed in many different ways, such as by using electroplating. In one embodiment, conductive fastener shaft 152 includes stainless steel, and the outer silver coating layer is formed thereon. In another embodiment, conductive fastener shaft 152 includes Type 306 Stainless Steel, and the outer silver coating layer is formed thereon. In another embodiment, conductive fastener shaft 152 includes Type 316 Stainless Steel, and the outer silver coating layer is formed thereon.

In some embodiments, the outer silver coating layer consists of silver and, in other embodiments, the outer silver coating layer consists essentially of silver. In some embodiments, the outer silver coating layer includes more than 95% silver.

It should be noted that electrode assembly 140 can be used in many different systems to condition a conductive fluid. For example, electrode assembly 140 can be included with a plumbing system to condition waste water. Further, electrode assembly 140 can be included with a water drinking system to condition drinking water.

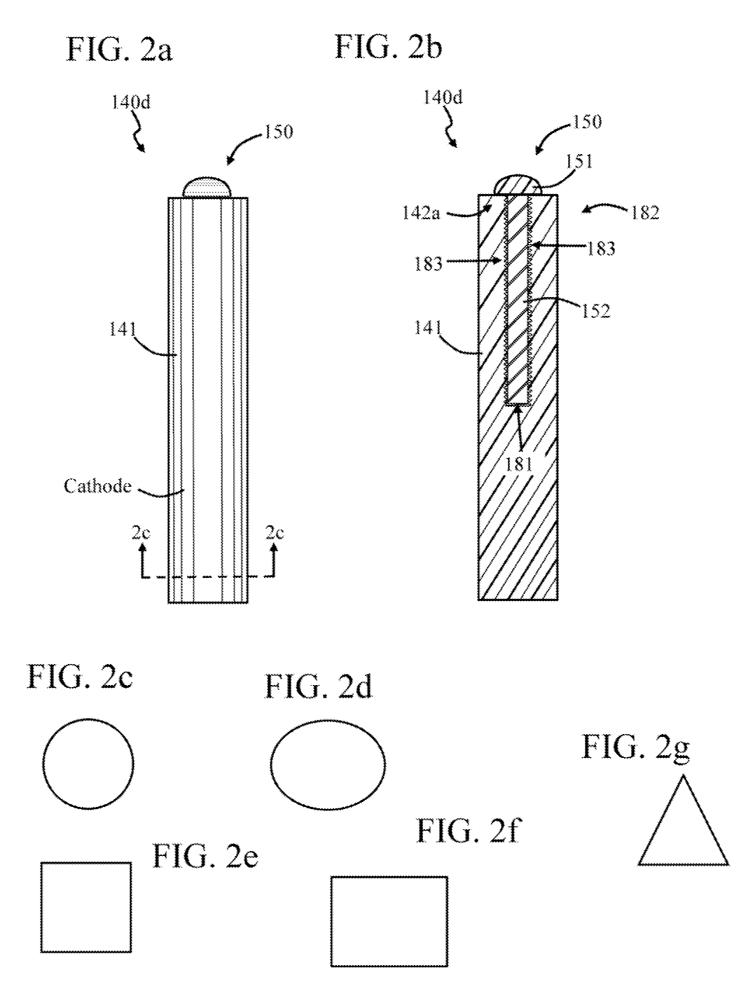

FIGS. 2a and 2b are side and cut-away side views, respectively, of an embodiment of an electrode assembly 140d, which corresponds to electrode assembly 140 of FIG. 1. In this embodiment, electrode assembly 140d includes an electrode body 141 and conductive fastener 150, wherein conductive fastener 150 extends through an electrode opening 142a of electrode body 141, as shown in FIG. 2b. Electrode body 141 can have many different shapes. In this embodiment, electrode body 141 is a generally cylindrical member.

FIG. 2c is a cross-sectional view of electrode assembly 140d of FIG. 2a taken along a cut-line 2c-2c, wherein the cross-sectional shape of electrode body 141 is circular.

FIG. 2d is a cross-sectional view of electrode assembly 140d of FIG. 2a taken along the cut-line 2c-2c, wherein the cross-sectional shape of electrode body 141 is elliptical.

FIG. 2e is a cross-sectional view of electrode assembly 140d of FIG. 2a taken along the cut-line 2c-2c, wherein the cross-sectional shape of electrode body 141 is square.

FIG. 2f is a cross-sectional view of electrode assembly 140d of FIG. 2a taken along the cut-line 2c-2c, wherein the cross-sectional shape of electrode body 141 is rectangular.

FIG. 2g is a cross-sectional view of electrode assembly 140d of FIG. 2a taken along the cut-line 2c-2c, wherein the cross-sectional shape of electrode body 141 is triangular. It should be noted that any of the cross-sectional shapes of electrode body 141 of FIGS. 2c-2g can be used with the other embodiments of electrode assemblies discussed herein.

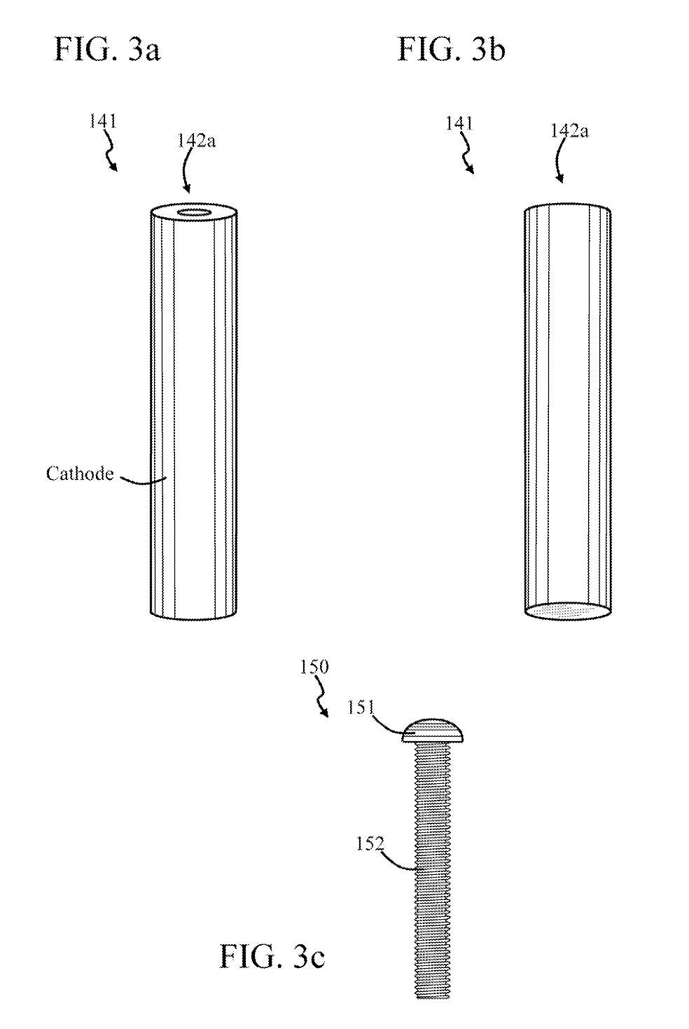

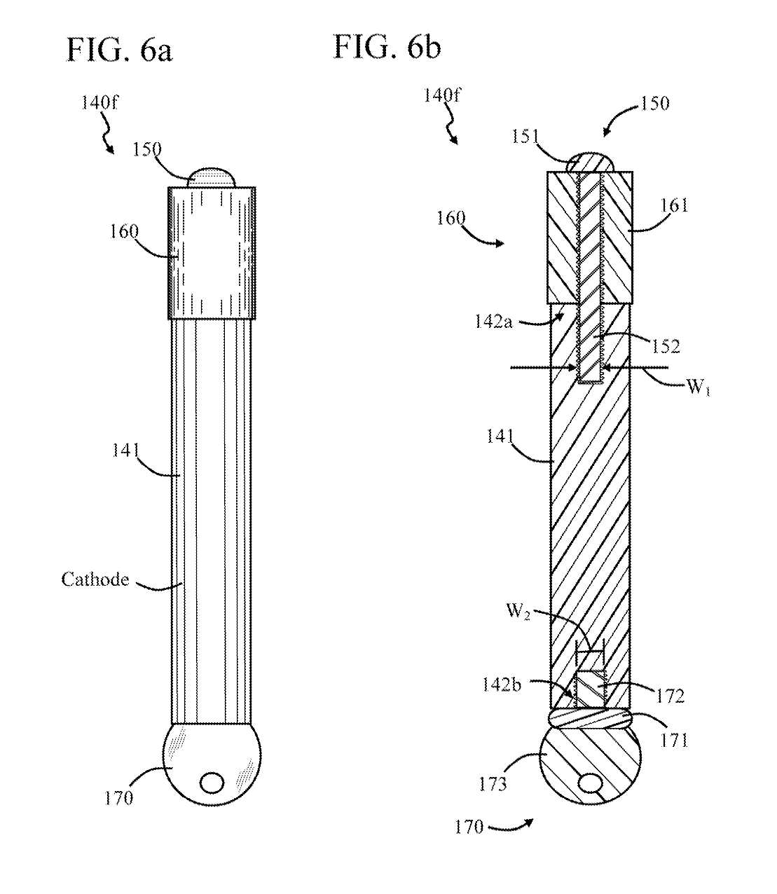

FIGS. 3a and 3b are opposed perspective views of electrode body 141, which show electrode opening 142a extending through one shortened end of electrode body 141. In some embodiments, electrode opening 142a can extend longitudinally through electrode body 141 between opposed shortened ends. In the embodiment of FIGS. 6a and 6b, electrode body 141 includes openings 142a and 142b, which extend through opposed shortened ends. It should be noted that a lengthened side of electrode body 141 extends between the opposed shortened ends of electrode body 141. In this embodiment, the lengthened side of electrode body 141 is an annular side because it extends annularly about the outer periphery of electrode body 141.

FIG. 3c is a perspective view of conductive fastener 150. In this embodiment, conductive fastener 150 includes a conductive fastener head 151 and conductive fastener shaft 152, wherein conductive fastener shaft 152 extends away from conductive fastener head 151 and through electrode opening 142a. Conductive fastener head 151 engages electrode body 141 proximate to electrode opening 142a. Conductive fastener shaft 152 establishes interfaces 181 and 183, which are discussed in more detail above. It should be noted that, in this embodiment, conductive fastener shaft 152 includes threads so that it is a threaded shaft. Hence, conductive fastener shaft 152 is threadingly engaged with electrode body 141. As mentioned above, the electrical current I flows through interfaces 181 and 183.

In this embodiment, fastener 150 and electrode body 141 are engaged together so that they are in communication with each other and a signal can flow between them. The signal flows between fastener 150 and electrode body 141 in response to establishing a potential difference between fastener 150 and electrode body 141. In this embodiment, the signal flows through the portions of fastener 150 and electrode body 141 that are engaged together proximate to region 182. In particular, the signal flows through interfaces 181 and 183.

Electrode assembly 140d is typically immersed in a fluid, as described in more detail above. Portions of fastener 150 and electrode body 141 are in contact with the fluid so that the electrical current I flows through the fluid and the portions of fastener 150 and electrode body 141 that are engaged together proximate to region 182. Further, portions of fastener 150 and/or electrode body 141 are in contact with the fluid so that the electrical current I flows through the fluid and between fastener 150 and electrode body 141 and interfaces 181 and 183.

Electrode body 141 can include many different types of conductive materials, such those mentioned in more detail above. In some embodiments, electrode body 141 includes an alloy of conductive material, such as an alloy of copper and silver. The material of electrode body 141 is ionized in response to flowing the electrical current I therethrough. It should be noted that the corrosion rate of the material of electrode body 141 increases proximate to region 182. The corrosion rate of the material of electrode body 141 increases proximate to region 182 because fastener 150 and electrode body 141 are engaged together proximate to region 182 and fastener 150 and electrode body 141 include dissimilar material.

The materials of fastener 150 and electrode body 141 are corroded in response to the electrical current I flowing therethrough. Hence, fastener 150 includes a material that is less susceptible to corrosion, such as titanium and a titanium alloy. As mentioned above, it is desirable to have the electrical current I flow through the titanium because the material of fastener 150 experiences less ionization in response to the electrical current I flowing through the titanium. It is desirable to have the titanium be positioned proximate to the outer periphery of conductive fastener 150 because the electrical current I flows proximate to the periphery of conductive fastener 150. It is desirable to have the titanium be positioned proximate region 182 because region 182 includes interfaces 181 and 183.

In general, the amount of titanium of fastener 150 is chosen to reduce the corrosion of the material of fastener 150 proximate to region 182 by a desired amount. The amount of titanium of fastener 150 depends on many different factors, such as those discussed in more detail above. In this embodiment, the amount of titanium chosen depends on the dimensions of interfaces 181 and 183. The amount of titanium chosen increases and decreases in response to increasing and decreasing, respectively, the dimension of interfaces 181 and 183.

Electrode body 141 can include many different types of conductive materials, such as copper and silver. In some embodiments, electrode body 141 includes an alloy of conductive material, such as an alloy of copper and silver. Hence, in some embodiments, interfaces 181 and 183 are titanium-copper interfaces when fastener 150 includes titanium and electrode body 141 includes copper. In some embodiments, interfaces 181 and 183 are titanium-silver interface when fastener 150 includes titanium and electrode body 141 includes silver. In some embodiments, region 182 includes titanium, copper and silver proximate to region 182 when fastener 150 includes titanium and electrode body 141 includes an alloy of copper and silver.

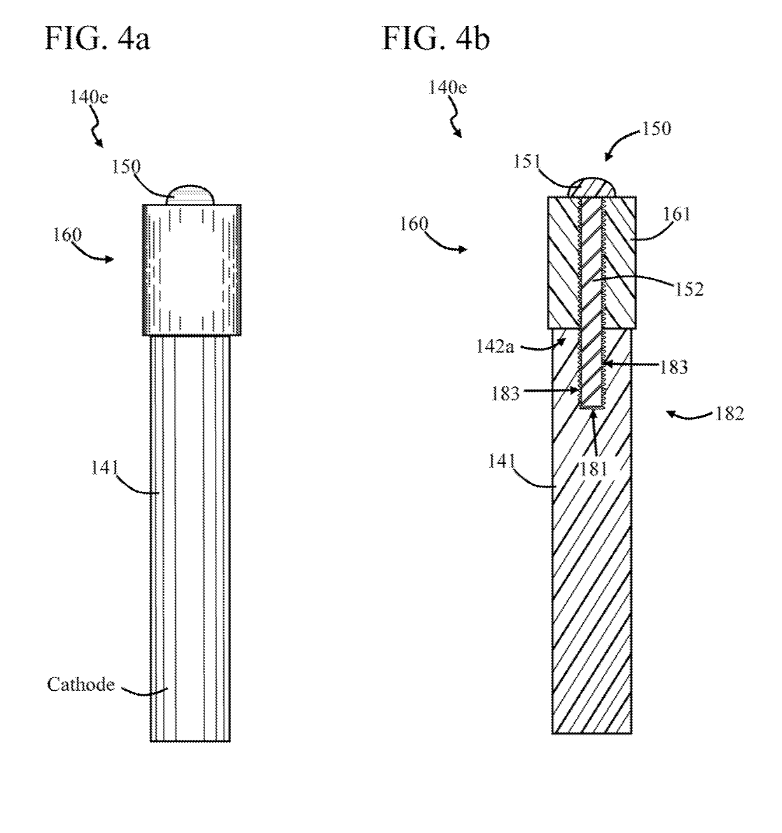

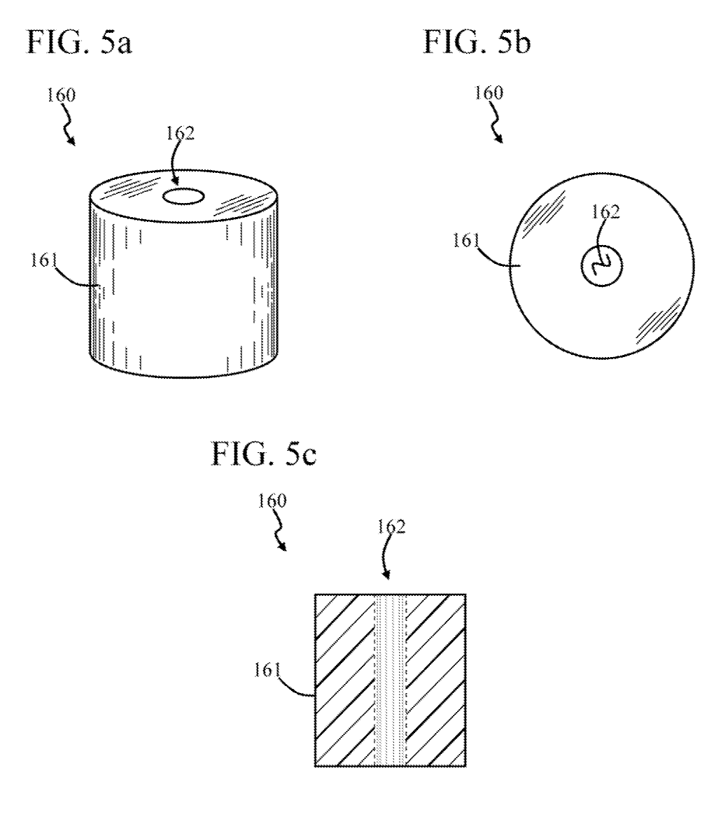

FIGS. 4a and 4b are side and cut-away side views, respectively, of an embodiment of an electrode assembly 140e. In this embodiment, electrode assembly 140d includes electrode body 141, electrically conductive fastener 150 and a fluidically sealing and electrically insulative bushing 160, wherein insulative bushing 160 includes an electrically insulative bushing body 161 with an insulative bushing channel 162 extending therethrough. It should be noted that electrode assembly 140d can include a coated fastener, if desired, several types of which are discussed in more detail above. Insulative bushing body 161 and channel 162 are shown in FIGS. 5a, 5b and 5c, and opening 142a is shown in FIG. 2b. Conductive fastener 150 extends through insulative bushing channel 162 and electrode opening 142a of electrode body 141. In this embodiment, conductive fastener head 151 is spaced from electrode opening 142a by insulative bushing body 161. Hence, conductive fastener head 151 is not engaged with electrode body 141.

Fastener 150 fastens electrically insulative bushing 160 to electrode body 141 to form a seal therebetween. In this way, electrically insulative bushing 160 restricts the ability of fluid to flow to the portion of conductive fastener 150 proximate to opening 142a. Further, electrically insulative bushing 160 is positioned in sealing engagement with conductive fastener head 152, electrically conductive fastener 150 and electrode body 141 to restrict the ability of the conductive fluid to flow to flow to conductive fastener shaft 152.

The materials of fastener 150 and electrode body 141 are discussed in more detail above. Insulative bushing 160 can include many different types of insulative materials, such as a polymer. There are many different types of polymers that can be included with insulative bushing 160, such as rubber and plastic. The material of insulative bushing 160 is less conductive than the material of conductive fastener 150. Further, the material of insulative bushing 160 is less conductive than the material of electrode body 141. Hence, the electrical current I does not flow through the material of insulative bushing 160. However, the electrical current I does flow through insulative bushing channel 162 because conductive fastener 150 extends therethrough.

FIG. 5a is a perspective view of insulative bushing 160, FIG. 5b is an end view of insulative bushing 160, and FIG. 5c is cut-away side view of insulative bushing 160. Insulative bushing 160 can have many different shapes. In this embodiment, insulative bushing 160 is a generally cylindrical member having an insulative bushing body 161, with insulative bushing channel 162 extending therethrough. Insulative bushing channel 162 extends through opposed ends of insulative bushing body 161, as shown in FIG. 5c, so that conductive fastener 150 can extend through opposed ends of insulative bushing body 161.

In this embodiment, insulative bushing channel 162 is aligned with electrode opening 142a, and conductive fastener 150 extends through insulative bushing channel 162 and electrode opening 142a. In particular, conductive fastener shaft 152 extends through insulative bushing channel 162 and electrode opening 142a.

In this embodiment, fastener 150 and electrode body 141 are engaged together so that they are in communication with each other and a signal can flow between them. The signal flows between fastener 150 and electrode body 141 in response to establishing a potential difference between fastener 150 and electrode body 141. In this embodiment, the signal flows through the portions of fastener 150 and electrode body 141 that are engaged together proximate to region 182. In particular, the signal flows through interfaces 181 and 183. The electrical current I corresponds to the signal so that the electrical current I flows through interfaces 181 and 183. It should be noted that interfaces 181 and 183 are established away from insulative bushing channel 162. Interfaces 181 and 183 are established away from insulative bushing channel 162 because they are established outside of insulative bushing body 161.

Electrode assembly 140e is typically immersed in a fluid, as described in more detail above. Portions of fastener 150 and electrode body 141 are in contact with the fluid so that the electrical current I flows through the fluid and the portions of fastener 150 and electrode body 141 that are engaged together proximate to region 182. Further, portions of fastener 150 and electrode body 141 are in contact with the fluid so that the electrical current I flows through the fluid and between fastener 150 and electrode body 141 and interfaces 181 and 183. It should be noted that the portion of fastener 150, which extends through insulative bushing 160, is not exposed to the fluid. In particular, the portion of conductive fastener shaft 152, which extends through insulative bushing channel 162, is not exposed to the fluid. Insulative bushing 160 reduces the corrosion rate of the portion of fastener 150 which extends through insulative bushing 160.

FIGS. 6a and 6b are side and cut-away side views, respectively, of an embodiment of an electrode assembly 140f. In this embodiment, electrode assembly 140d includes electrode body 141, electrically conductive fastener 150, an insulative bushing 160 and an insulative fastener 170. In this embodiment, conductive fastener 150 extends through insulative bushing channel 162 and electrode opening 142a of electrode body 141. Conductive fastener 150 fastens insulative bushing body 161 to electrode body 141. It should be noted that electrode assembly 140f can include electrically a coated fastener, if desired.

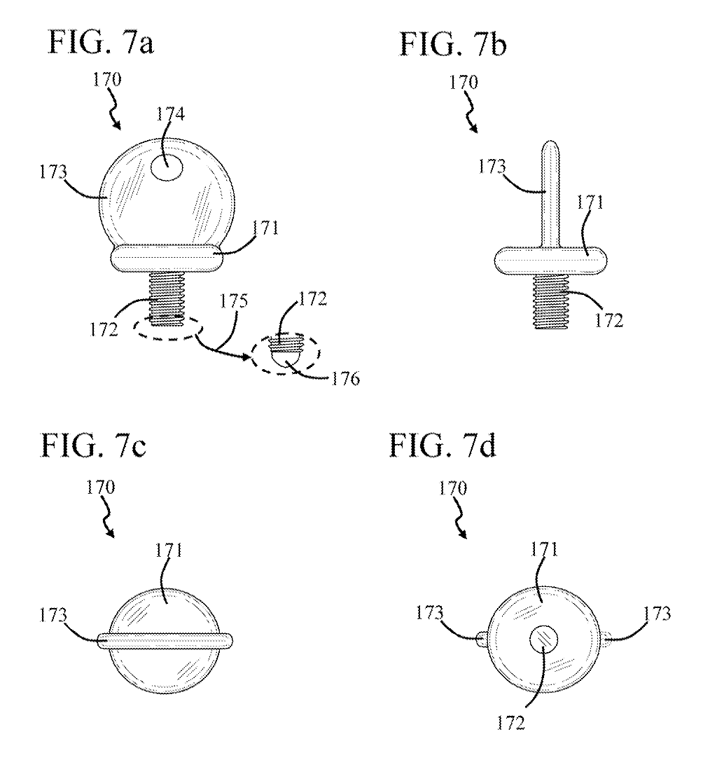

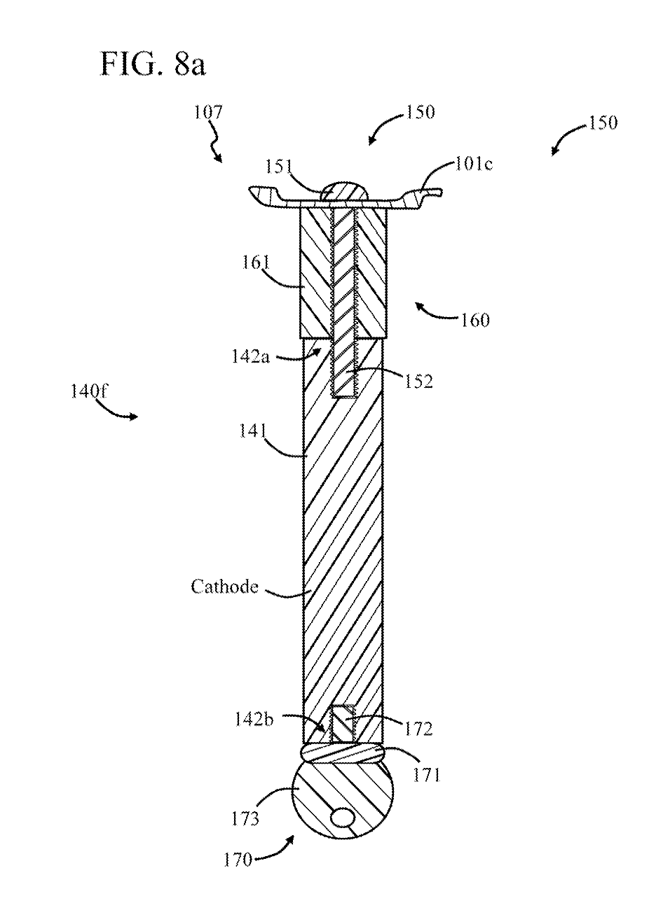

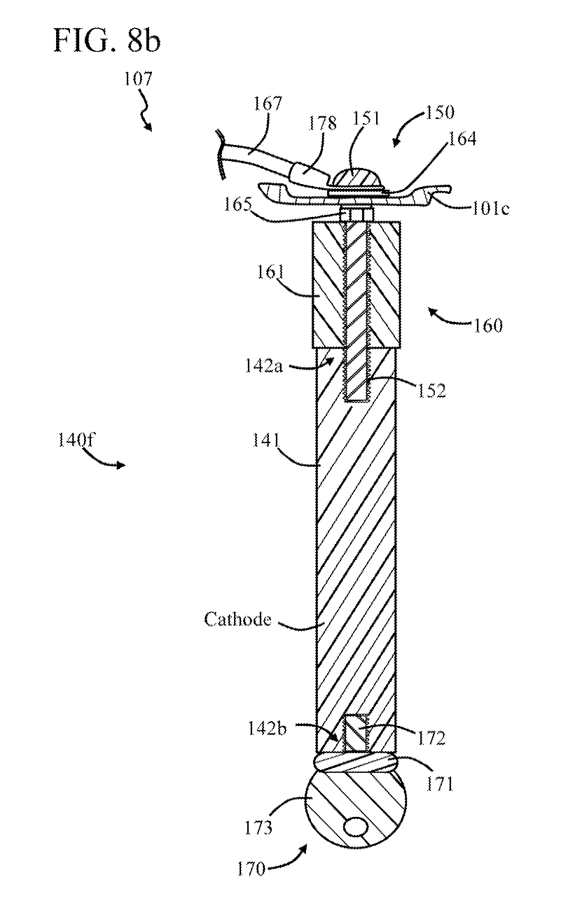

Further, insulative fastener 170 extends through an electrode opening 142b, wherein electrode openings 142a and 142b are opposed to each other. Insulative fastener 170 is shown in FIGS. 7a, 7b, 7c and 7d, and will be discussed in more detail with these drawings. Insulative fastener 170 is also shown in FIGS. 8a, b, 9a and 11b.

In this embodiment, electrode openings 142a and 142b have widths W₁ and W₂, respectively. Widths W₁ and W₂ correspond to the diameters of corresponding electrodes openings 142a and 142b. In this embodiment, width W₂ is larger than width W₁ so that electrode opening 142b has a larger diameter than electrode opening 142a. It is useful to have width W₂ be larger than width W₁ to reduce the rate of corrosion experienced by electrode body 141. In some embodiments, widths W₁ and W₂ have the same values so that electrode openings 142a and 142b have the same diameters. In some embodiments, width W₁ is larger than width Wₛ so that electrode opening 142a has a larger diameter than electrode opening 142b. In general, widths W₁ and W₂ have different diameter values so that insulative fastener 170 cannot be threadingly engaged with opening 142a and electrically conductive fastener 150 cannot be threadingly engaged with opening 142b.

The materials of fastener 150, electrode body 141 and insulative bushing 160 are discussed in more detail above. Insulative fastener 170 can include many different types of insulative materials, such as a polymer. There are many different types of polymers that can be included with insulative fastener 170, such as rubber and plastic. The material of insulative fastener 170 is less conductive than the material of conductive fastener 150. Further, the material of fastener 170 is less conductive than the material of electrode body 141. Hence, the electrical current I does not flow through the material of insulative fastener 170.

FIGS. 7a and 7b are front and side views, respectively, of insulative fastener 170. FIGS. 7c and 7d are top and bottom views, respectively, of insulative fastener 170. In this embodiment, insulative fastener 170 includes an insulative fastener base 171, and an insulative fastener shaft 172 and insulative fastener grip 173 extending from opposed sides. Insulative fastener shaft 172 is a threaded shaft which is threadingly engaged with electrode body 141, as shown in FIGS. 6a and 6b. Insulative fastener grip 173 includes an insulative fastener grip opening 174. As indicated by an indication arrow 175 in FIG. 7a, some embodiments of insulative fastener 170 includes a tapered end 176 to facilitate its ability to form a seal with electrode body 141. Tapered end 176 also restricts the ability of insulative fastener to become unthreaded from electrode opening 142b, which is shown in FIGS. 8a and 8b.

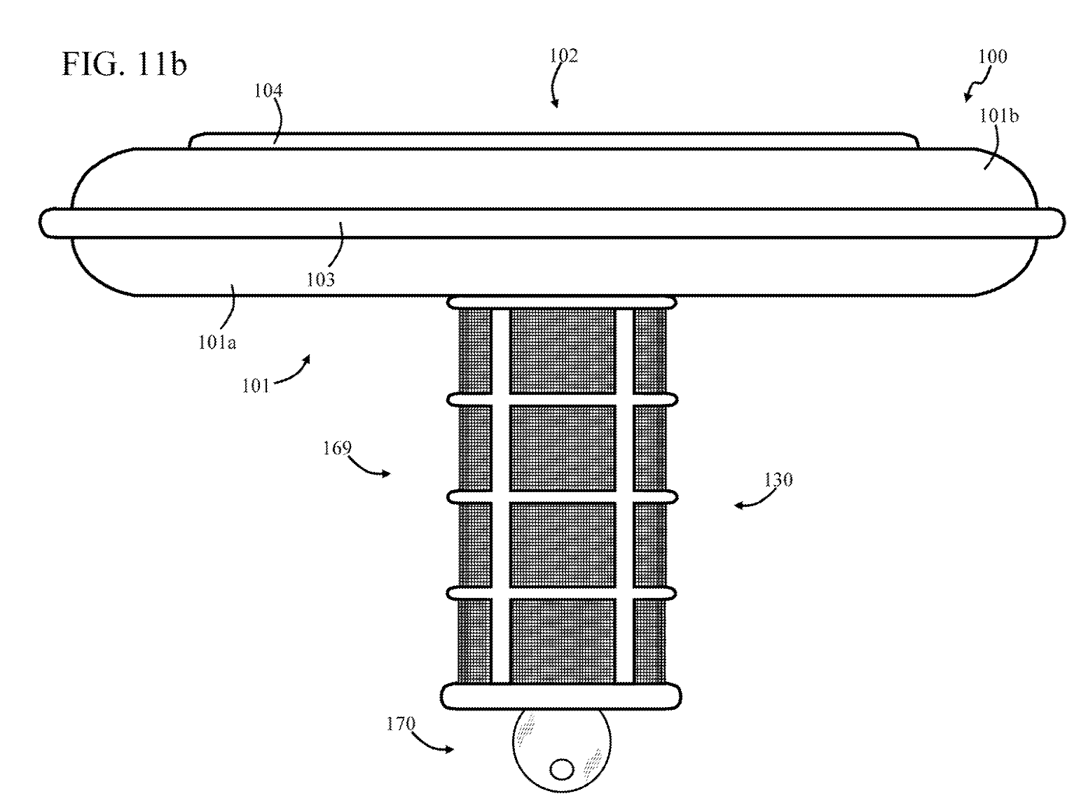

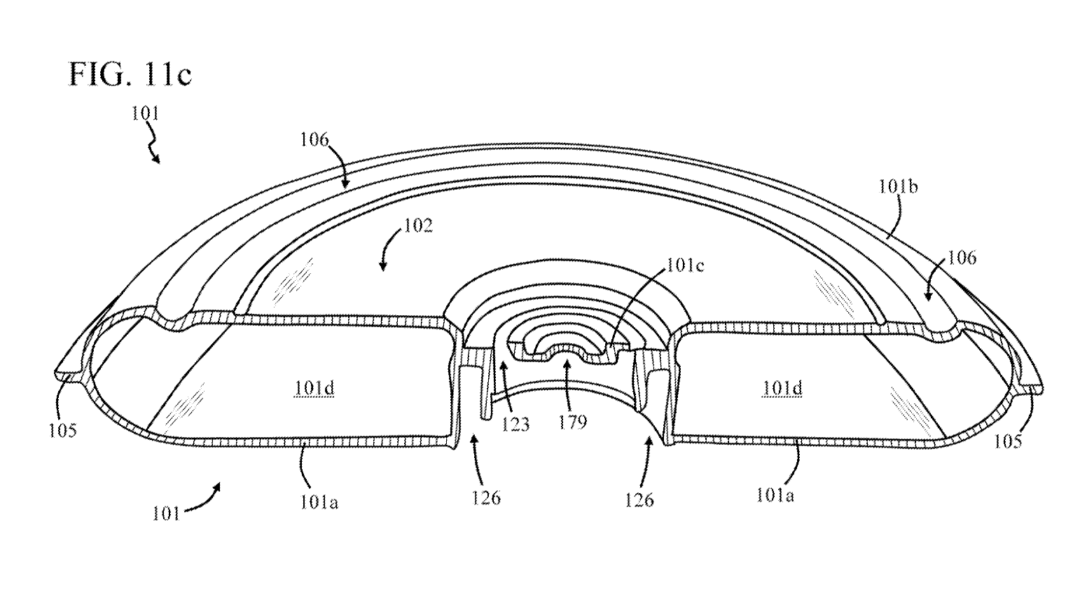

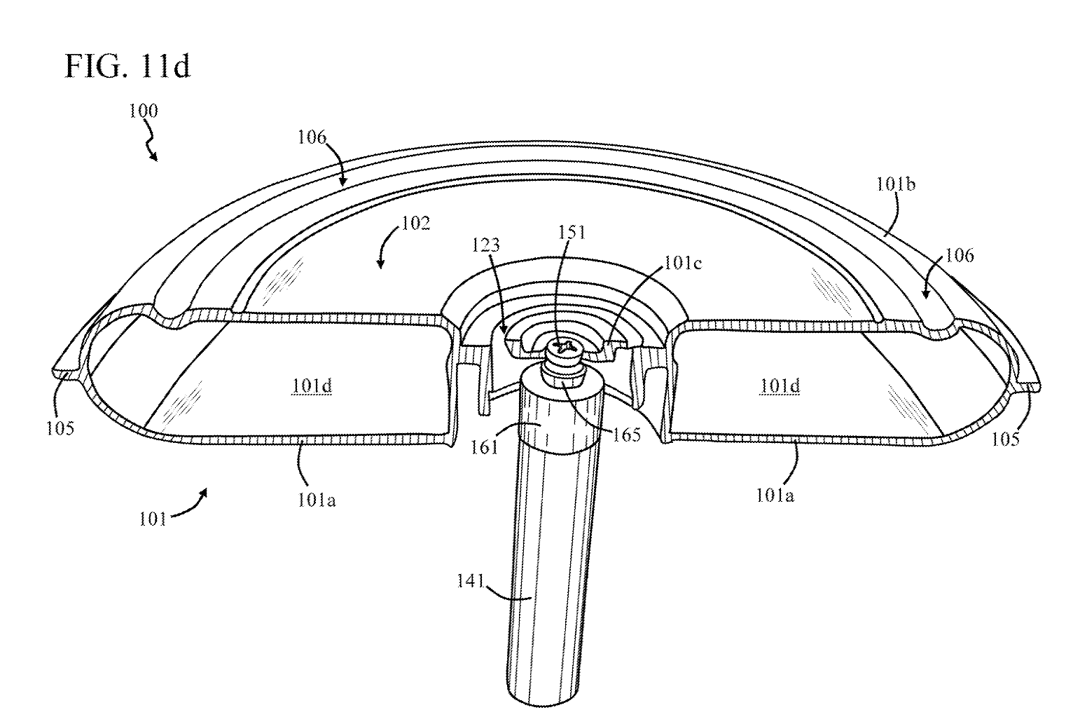

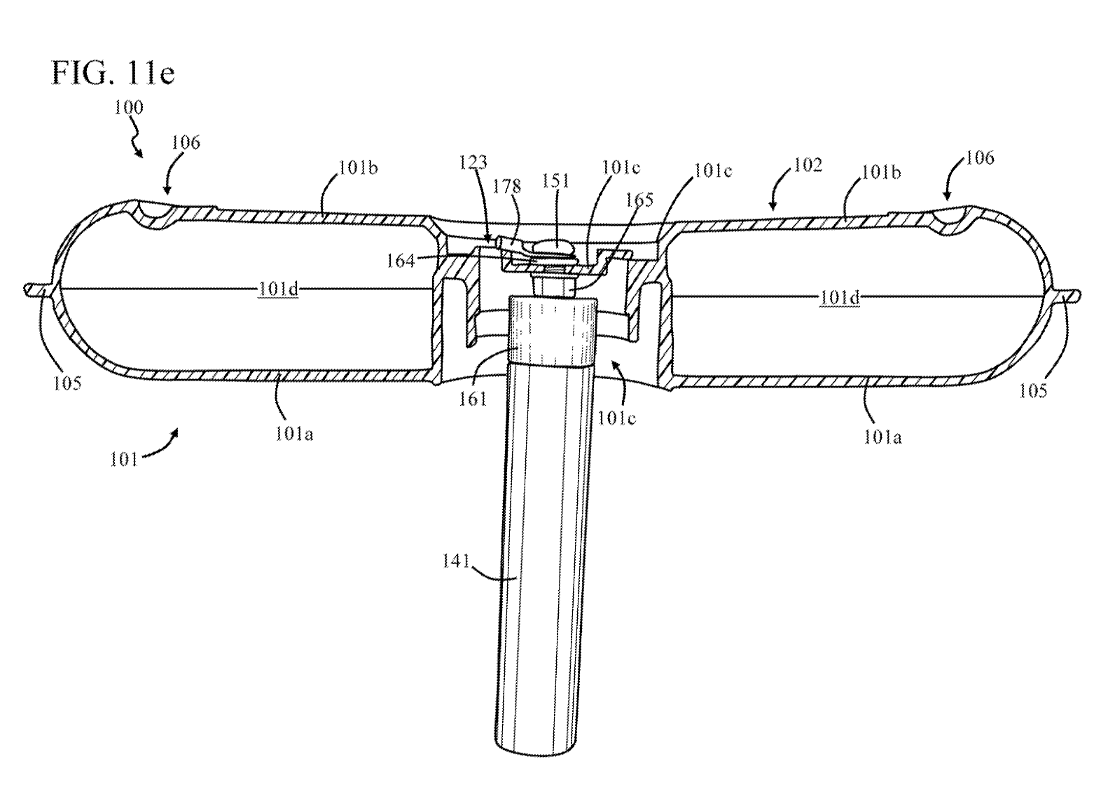

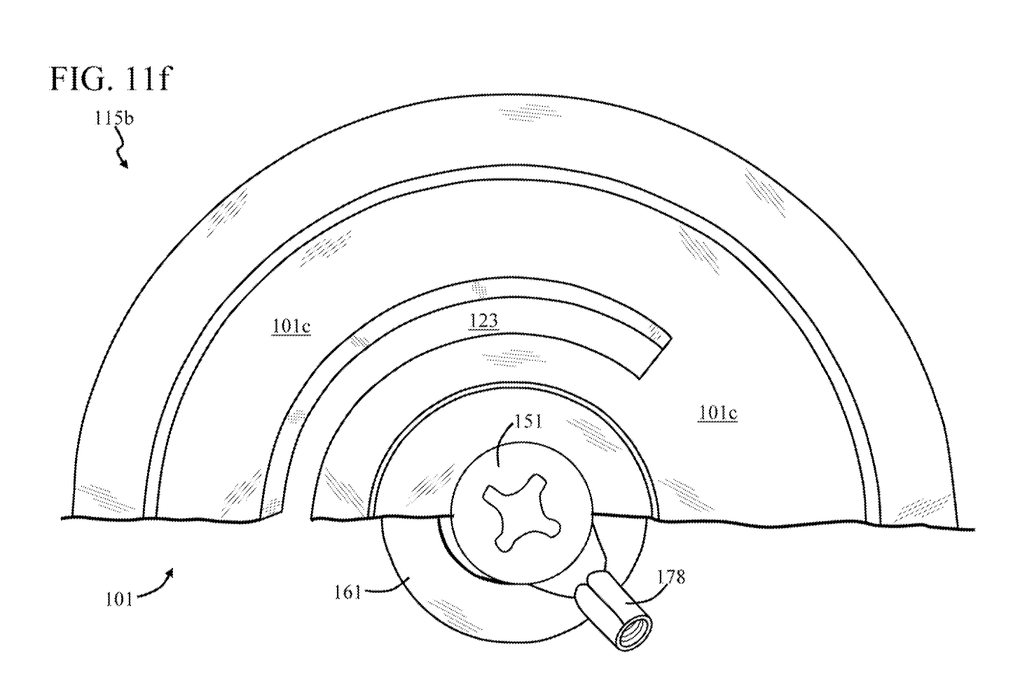

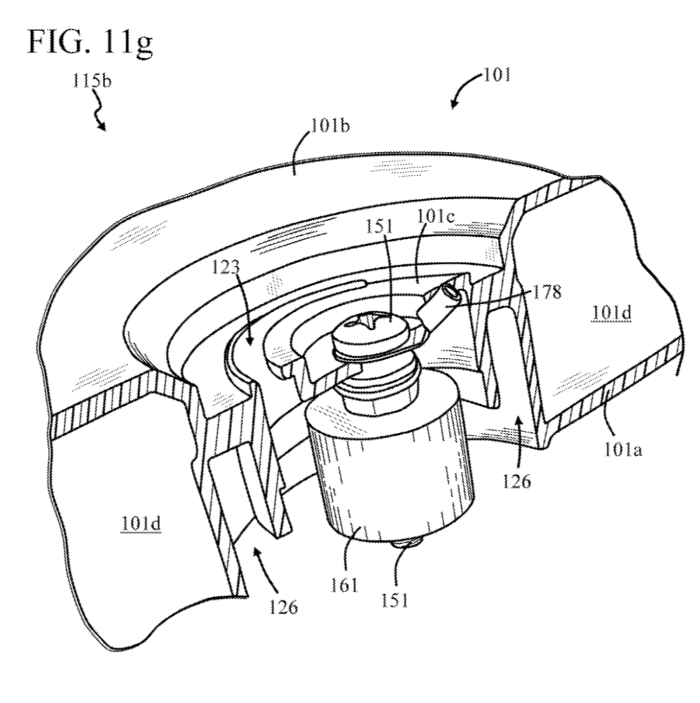

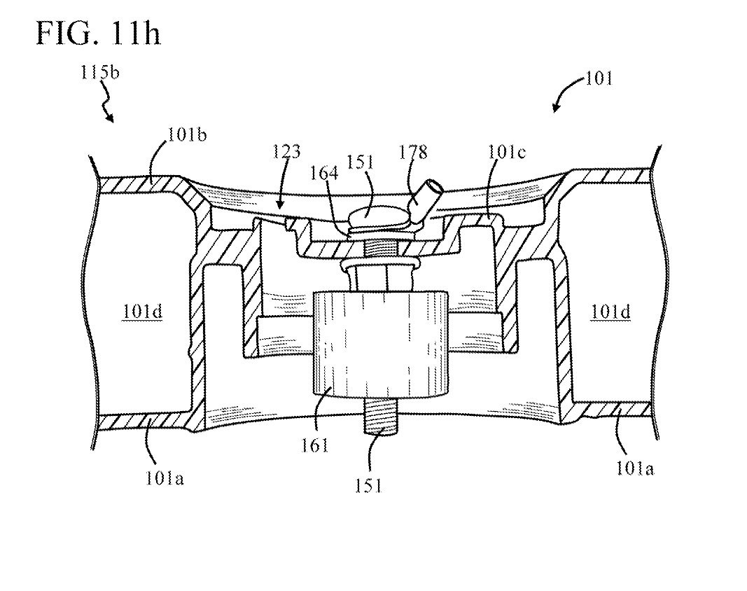

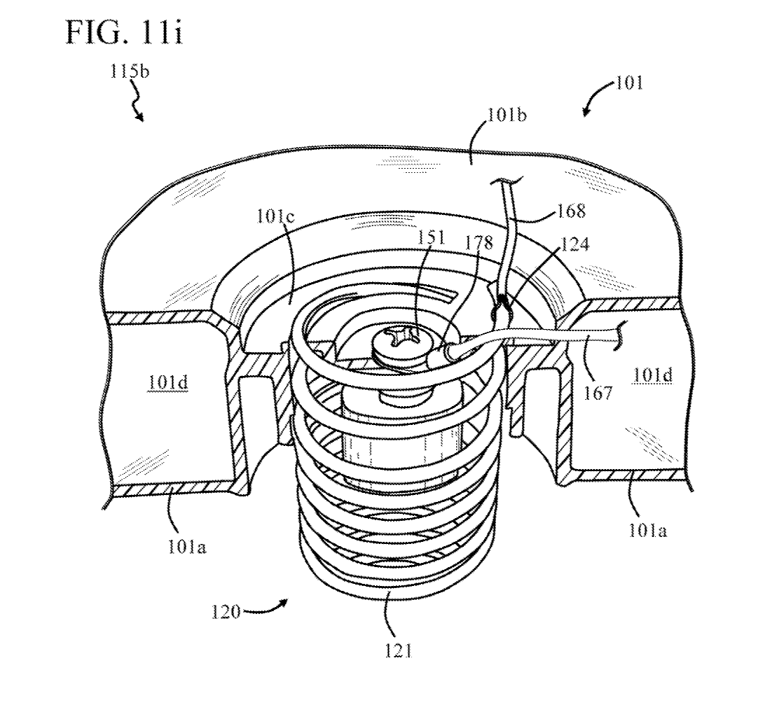

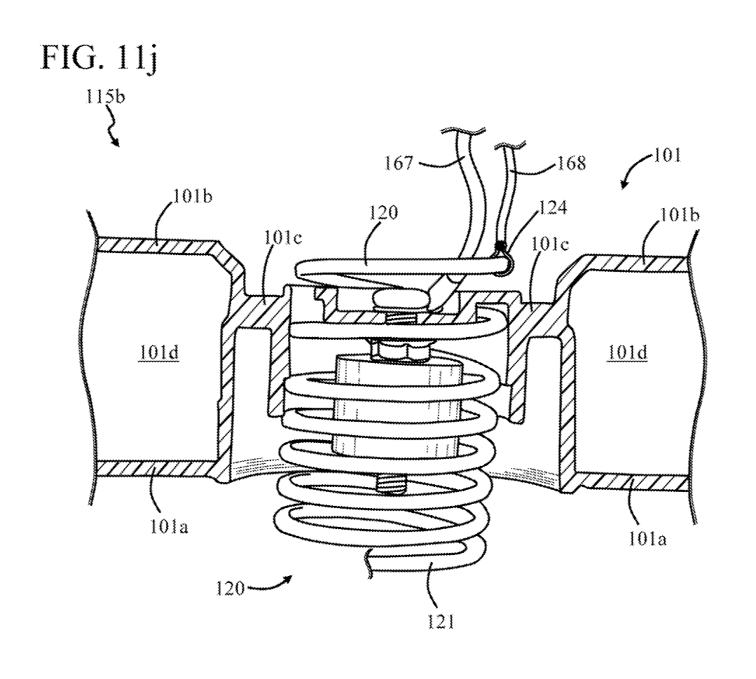

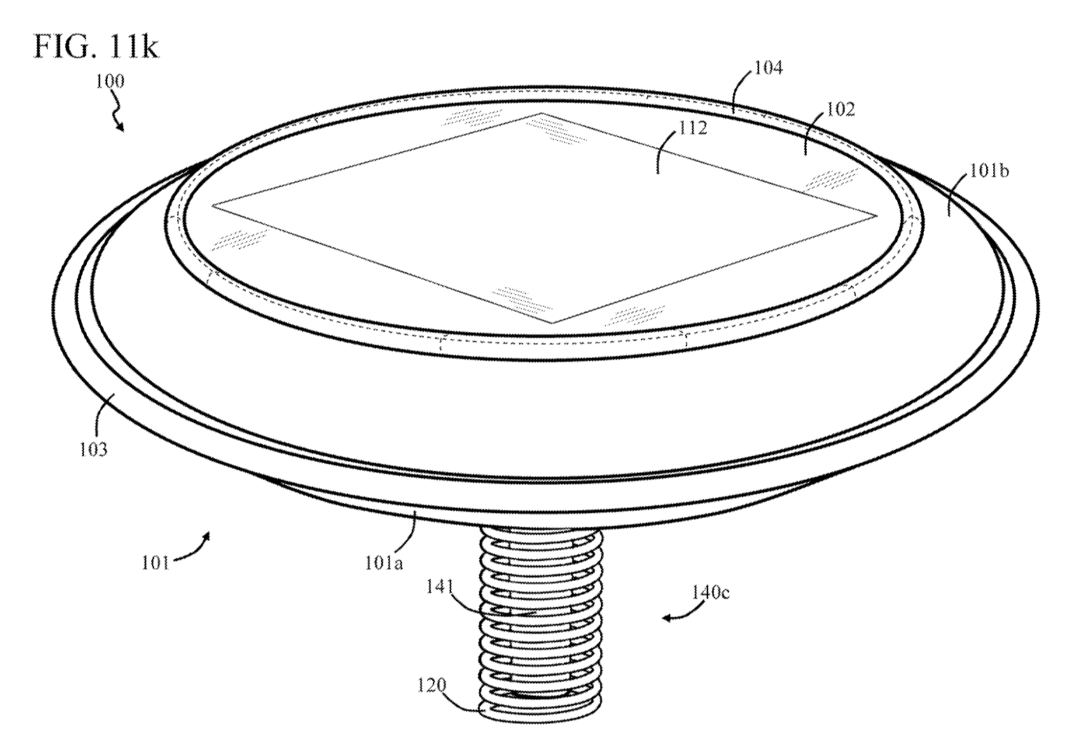

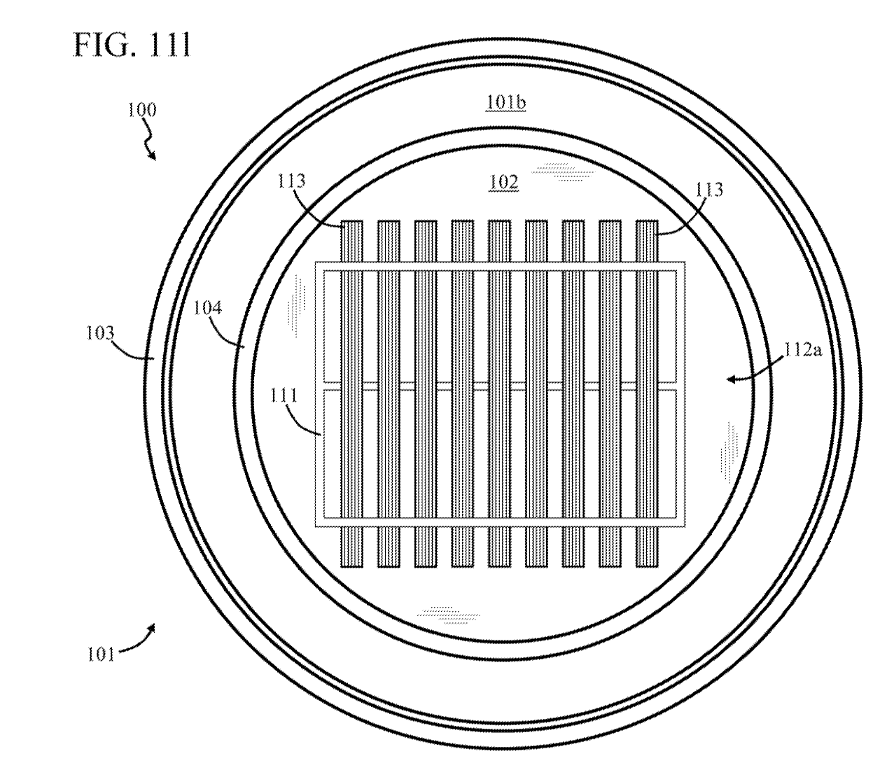

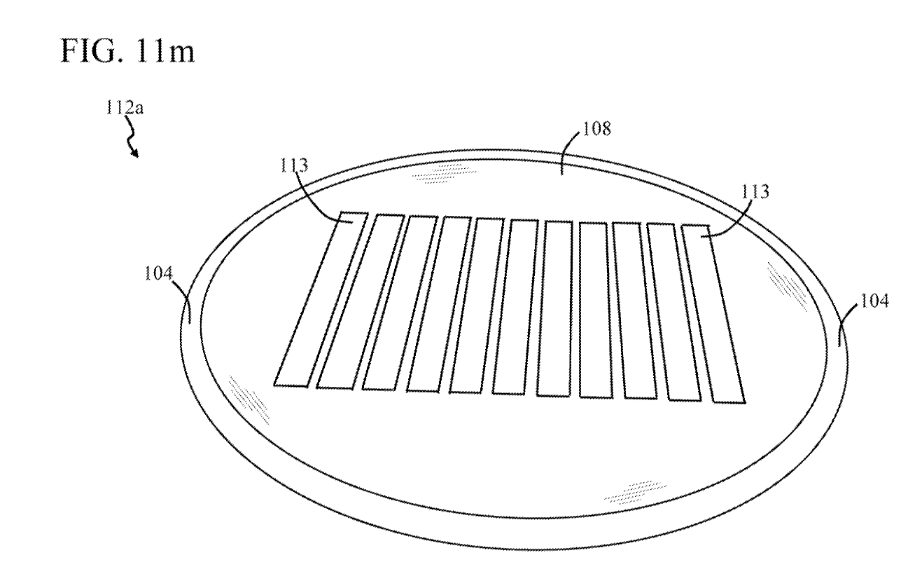

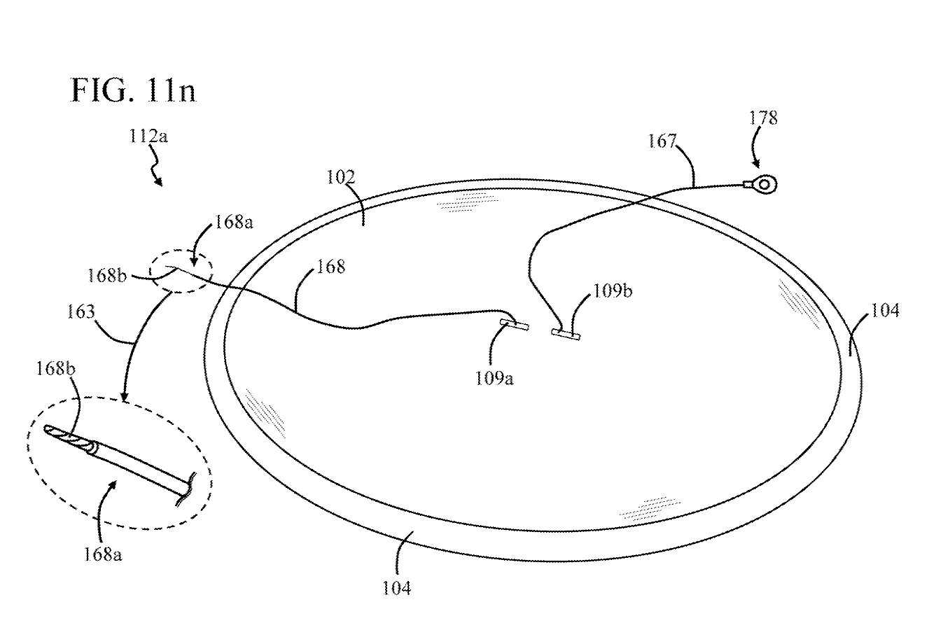

FIG. 8a is a cut-away side view of electrode assembly 140f carried by a portion of a support substrate, which is embodied as a housing central portion 101c. Housing central portion 101c will be discussed in more detail with FIGS. 11c, 11d and 11e. It should be noted that electrode assembly 140f can be replaced with the other electrode assemblies disclosed herein. In this embodiment, electrode assembly 140f is shown for illustrative purposes.

In this embodiment, housing central portion 101c includes a housing central portion opening 179 (FIGS. 11c, 11d and 11e) through which fastener 150 extends. In particular, fastener shaft 152 extends through housing central portion opening 179 so that fastener head 151 and insulative bushing 160 are on opposed sides of housing central portion 101c. In this way, housing central portion 101c is coupled between fastener head 151 and insulative bushing 160, and electrode assembly 140f is coupled to housing central portion 101c. As mentioned in more detail above with FIGS. 6a and 6b, insulative fastener 170 is fastened to electrode body 141. Hence, electrode body 141 extends between insulative fastener 170 and insulative bushing body 161. It should be noted that circuit board assembly 107 of FIG. 8a can include a coated fastener, if desired.

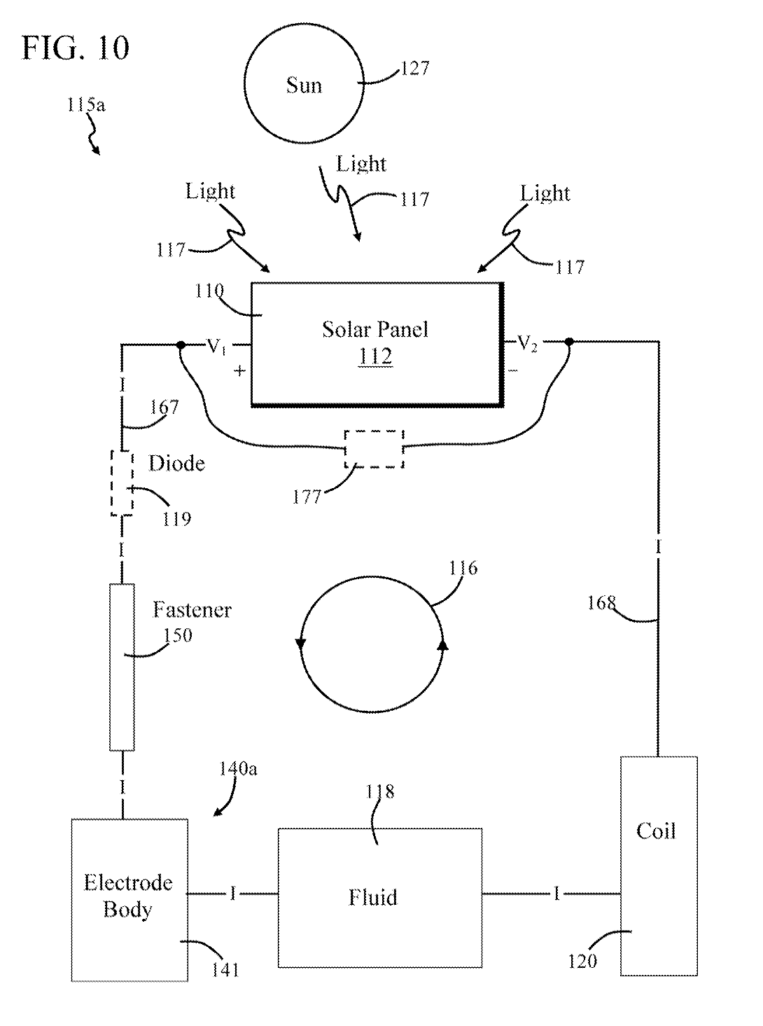

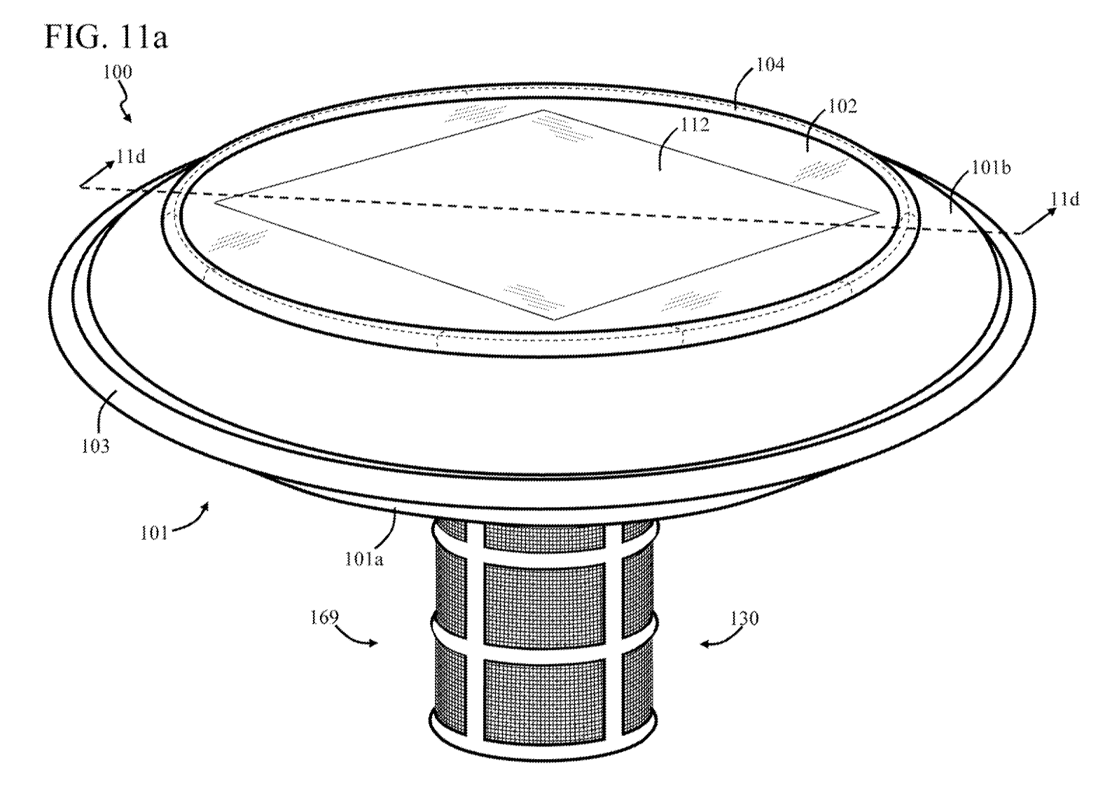

FIG. 8b is a cut-away side view of another embodiment of electrode assembly 140f carried by housing central portion 101c, as discussed in more detail above with FIG. 8a. In this embodiment, an electrical connector 178 is positioned proximate to housing central portion opening 179 and fastener 150 extends therethrough so that electrical connector 178 is fastened to housing central portion 101c. A conductive line 167 is electrically connected to electrical connector 178 so that is it in electrical communication with fastener 150 through electrical connector 178. Conductive line 167 can be of many different types, such as a wire sheathed in an outer plastic coating. Conductive line 167 and/or electrical connector 178 are also shown in FIGS. 10, 11i and 11j. It should be noted that circuit board assembly 107 of FIG. 8b can include a coated fastener, if desired.

In this embodiment, fastener 150 extends through an electrically conductive washer 164, which is positioned at the same side of housing central portion 101c as electrical connector 178. A nut 165 is threadingly engaged with fastener 150 so that housing central portion 101c is held between nut 165 and washer 164. Fastener 150 extends through insulative bushing body 161 and electrode body 141, as described in more detail above with FIG. 8a.

In this embodiment, electrode body 141 is in communication with conductive line 167 and electrical connector 178 through fastener 150. In this way, a potential V₁ applied to conductive line 167 is applied to conductive body 141. The potential V₁ can be applied to conductive line 167 in many different ways, such as with a solar panel, as will be discussed in more detail below.

The electrical current I flows between conductive fastener shall 152 and conductive line 167 and electrical connector 178. As discussed in more detail above with FIGS. 6a and 6b, conductive fastener 150 is coupled to electrode body 141 through insulative sleeve 161. Hence, the electrical current I flows between electrode body 141 and electrical connector 178 and through conductive fastener shaft 152.

As discussed in more detail above with FIGS. 6a and 6b, insulative fastener 170 is coupled to electrode body 141 at the shortened end opposed to conductive fastener 150. In this embodiment, the electrical current I flows between electrode body 141, electrical connector 178 and conductive fastener shaft 152. However, insulative fastener 170 restricts the ability of the electrical current I to flow through the shortened end opposed to conductive fastener 150. In particular, insulative fastener base 171 restricts the ability of the electrical current I to flow through the shortened end opposed to conductive fastener 150. In this way, the amount of corrosion experienced by the distal end of electrode body 141 is reduced.

As mentioned above with the discussion of FIGS. 3a and 3b, electrode body 141 includes at lengthened side which extends between opposed shortened ends. The electrical current I flows through the lengthened side of electrode body 141 in response to insulative fastener 170 being coupled to the opposed shortened end of electrode body 141, wherein the opposed shortened end of electrode body 141 is opposed to conductive fastener 150. The electrical current I flows radially outwardly from electrode body 141 because, as discussed above, the lengthened side of electrode body 141 is an annular side.

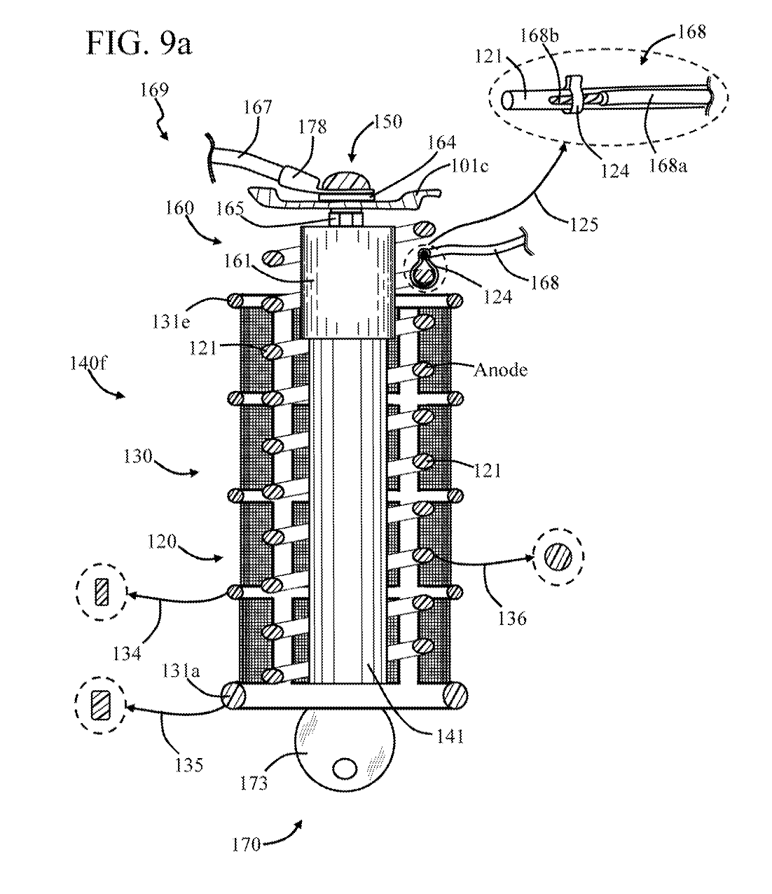

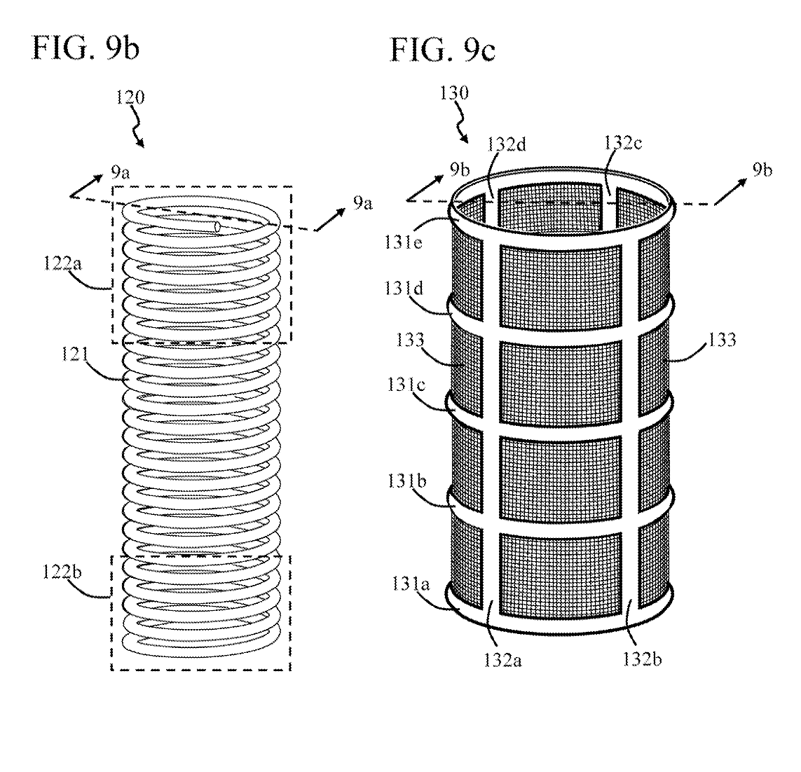

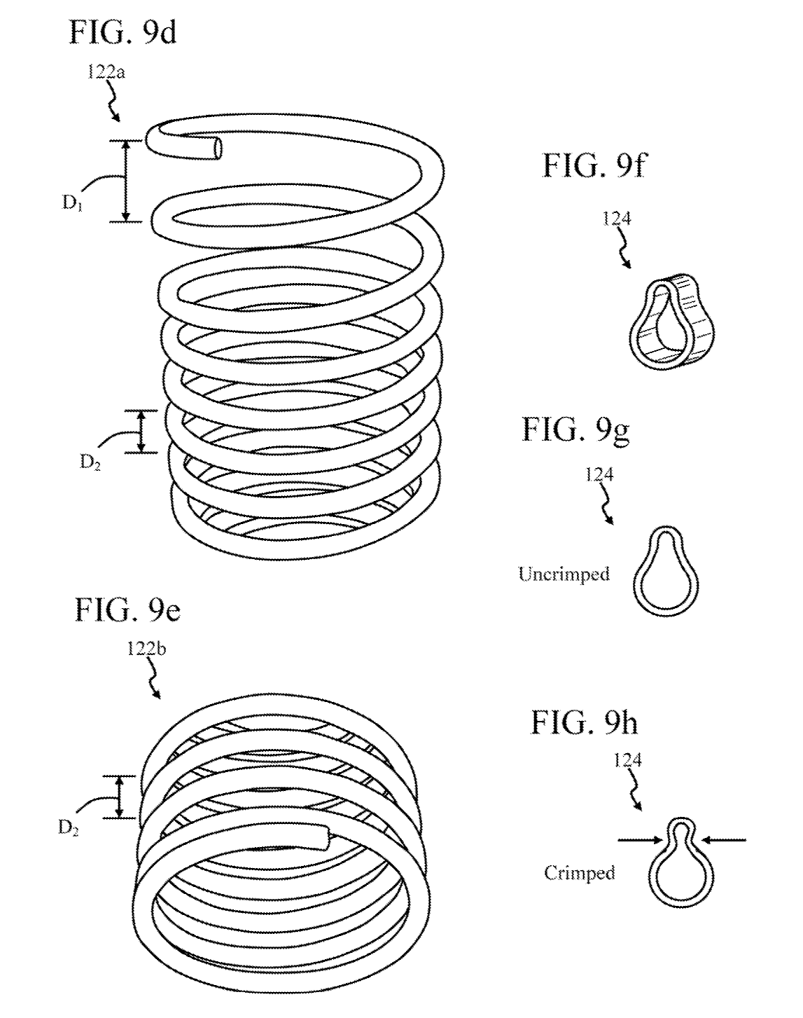

FIG. 9a is a partial cut-away side view of a strainer assembly 169, which includes electrode assembly 140f of FIG. 8b, a conductive coil 120, as shown in FIG. 9b and strainer basket 130, as shown in FIG. 9c. It should be noted that electrode assembly 140f can be replaced with the other electrode assemblies disclosed herein. In this embodiment, strainer assembly 169 includes electrode assembly 140f of FIG. 8b for illustrative purposes. It should be noted that the view of strainer basket 130 of FIG. 9a is taken along a cut-line 9b-9b Of FIG. 9c, as discussed below.

In this embodiment, strainer assembly 169 includes conductive coil 120, through which electrode assembly 140f extends. In particular, electrode body 141 and insulative bushing 160 extend through conductive coil 120. Insulative bushing 160 restricts the ability of conductive fastener 150 and electrode body 141 to engage conductive coil 120. Conductive coil 120 operates as a cathode, as discussed in more detail above with FIG. 1, wherein conductive coil 120 corresponds with cathode 156. It should be noted that strainer assembly 169 extends through the conductive fluid during operation. However, conductive fastener 150 is not exposed to the conductive fluid during normal operation. It should also be noted that strainer assembly 169 can include a coated fastener, if desired.

Conductive coil 120 can have many different shapes. In this embodiment, conductive coil 120 has a conductive coil winding 121 which is helical in shape. Conductive coil winding 121 has a plurality of coil windings which are spaced apart from each other. It should be noted that the view of conductive coil 120 of FIG. 9a is taken along a cut-line 9a-9a of FIG. 9b. It should be noted that conductive coil winding 121 can have many different cross-sectional shapes. In FIG. 9a, conductive coil winding 121 is shown as having an elliptical cross-sectional shape. However, as indicated by an indication arrow 136 in FIG. 9a, one or more of coils 121 can have a circular cross-sectional shape. In other embodiments, one or more of coils 121 can have a rectangular cross-sectional shape. Conductive coil 120 is electrically conductive so that current can flow therethrough. In general, conductive coil 120 includes a metal.

In this embodiment, a conductive line 168 is electrically connected to conductive coil 120 so that it is in electrical communication therewith. It should be noted that conductive line 168 is also shown in FIGS. 10, 11i, 11j and 11n. Conductive line 168 can be electrically connected to conductive coil 120 in many different ways, such as by soldering, welding and by using a conductive glue. There are many different types of welding that can be used, such as capacitive discharge welding and spot welding.

In this embodiment, conductive line 168 is connected to conductive coil winding 121 with a clamp 124, as indicated in an indication arrow 125. Clamp 124 operates as an electrical connector and is discussed in more detail with FIGS. 9f, 9g and 9h. Conductive line 168 can be of many different types, such as a wire 168b sheathed in an outer insulative coating 168a, as indicated in an indication arrow 125. It should be noted that outer insulative coating 168a and wire 168b are also shown below in FIG. 11n. It should also be noted that conductive line 168 can be connected to conductive coil winding 121 in many other ways, such as by using spot welding.

In this embodiment, coil 120 is in communication with conductive line 168 so that a potential V₂ applied to conductive line 168 is applied to conductive coil 120. The potential V₂ can be applied to conductive line 168 in many different ways, such as with a solar panel, as will be discussed in more detail below.

FIG. 9d is a side perspective view of a portion of conductive coil 120 in a region 122a of FIG. 9b. In this embodiment, conductive coil 120 includes adjacent coils, proximate to its upper portion, which are spaced apart by a distance D₁. The upper portion of conductive coil 120 is positioned proximate to insulative bushing 160 in FIG. 9a. Further, in this embodiment, conductive coil 120 includes adjacent coils, away from its upper portion, which are spaced apart by a distance D₂.

FIG. 9e is a side perspective view of a portion of conductive coil 120 in a region 122b of FIG. 9b. In this embodiment, conductive coil 120 includes adjacent coils, in region 122b, which are spaced apart by distance D₂.

FIG. 9f is a perspective view of clamp 124 included with strainer assembly 169 of FIG. 9a, and FIGS. 9g and 9h are front views of clamp 124 of FIG. 9f in uncrimped and crimped conditions, respectively. In this embodiment, clamp 124 is an Oetiker-type clamp, examples of which can be found in U.S. Pat. Nos. 3,402,436, 4,451,955 and 7,434,440. In the Oetiker-type clamp, conductive coil winding 121 is extended through one portion of the clamp, and wire 168b is extended through another portion of the clamp, as shown in FIG. 9a. Clamp 124 is crimped (FIG. 9h) so that clamp 124 holds wire 168b to conductive coil winding 121 and an electrical connection is established therebetween. In this way, clamp 124 operates as an electrical connector.

In this embodiment, electrode assembly 140f and conductive coil 120 are in communication with each other so that the signal can flow between them. In particular, conductive fastener 150 and electrode body 141 are coupled together, as described in more detail above, and electrode body 141 and conductive coil 120 are in communication with each other so that the signal can flow between them. The signal flows between electrode body 141 and conductive coil 120 in response to establishing a potential difference between electrode body 141 and conductive coil 120. In particular, the signal flows between electrode body 141 and conductive coil 120 in response to establishing a potential difference between conductive fastener 150 and conductive coil 120. The potential difference can be established in many different ways, such as providing potential V₁ to conductive line 167 and potential V₂ to conductive line 168, wherein the potential difference is the difference between potentials V₁ and V₂. As mentioned above, the potential difference can have positive and negative voltage values. Potentials V₁ and V₂ can be provided in many different ways, such as by using a solar panel. The electrical current I flows between electrode body 141 and conductive coil 120 in response to establishing the potential difference between conductive fastener 150 and conductive coil 120. The electrical current I increases and decreases in response to increasing and decreasing, respectively, the potential difference.

It should be noted that electrode assembly 140f is immersed in a fluid during operation. In particular, portions of electrode assembly 140f and conductive cod 120 are in contact with the fluid. Portions of electrode assembly 140f and conductive coil 120 are in contact with the fluid so that the electrical current I flows through the fluid. Portions of electrode assembly 140f and conductive coil 120 are in contact with the fluid so that the electrical current I flows through the fluid and between electrode assembly 140f and conductive coil 120. In this way, the fluid and the undesirable material of the fluid is ionized.

In this embodiment, strainer assembly 169 includes a strainer basket 130, wherein electrode assembly 140f and conductive coil 120 extend through strainer basket 130. In particular, conductive coil is positioned between electrode assembly 140f and strainer basket 130. Strainer basket 130 restricts the ability of portions of the undesirable material of the fluid to flow to electrode assembly 140f and conductive coil 120. The portions of the undesirable material of the fluid restricted from flowing to electrode assembly 140f and conductive coil 120 includes material of a predetermined size, as will be discussed in more detail below. It should be noted that strainer basket 130 typically includes insulative material, such as plastic and/or rubber.

It should also be noted that insulative fastener 170 couples strainer basket 130 to electrode assembly 140f. In particular, insulative fastener shaft 172 extends through annular basket end cap 131a, and insulative fastener base 171 engages strainer basket 130 so that strainer basket 130 is coupled to electrode body 141.

Strainer basket 130 can have many different shapes. In this embodiment, strainer basket 130 includes annular basket end cap 131a and annular basket ribs 131b, 131c, 131d and 131e, which are annular in shape and spaced apart from each other in a longitudinal direction. Annular basket end cap 131a is positioned proximate to insulative fastener 170 and annular basket rib 131e (FIG. 9a) is positioned proximate to insulative bushing 160. Further, annular basket rib 131d is positioned between annular basket ribs 131e and 131c, annular basket rib 131c is positioned between annular basket rib 131b and 131d, annular basket rib 131b is positioned between annular basket end cap 131a and annular basket ribs 131c. Annular basket end cap 131a is positioned at an end of strainer basket 130 opposed to annular basket rib 131e, which is proximate to insulative fastener 170. It should be noted that strainer basket 130 can include fewer or more annular basket ribs, and five annular basket ribs are shown in this embodiment for illustrative purposes. It should also be noted that the ribs of strainer basket 130 can have many different cross-sectional shapes. In FIG. 9a, ribs 131a, 131b, 131c, 131d and 131e are shown as having a circular cross-sectional shape. However, as indicated by an indication arrows 135 and 136 in FIG. 9a, one or more of the ribs can have a rectangular cross-sectional shape.

In this embodiment, strainer basket 130 includes longitudinal basket ribs 132a, 132b, 132c and 112d, which are spaced apart from each other and extend in the longitudinal direction of strainer basket 130.

Longitudinal basket ribs 132a and 132c are positioned opposed to each other, and longitudinal basket ribs 132a and 132c are positioned opposed to each other. Further, longitudinal basket ribs 132a, 132b, 132c and 132d extend through annular basket end cap 131a and annular basket ribs 131b, 131c, 131d and 131e. It should be noted that strainer basket 130 can include fewer or more longitudinal basket ribs, and four longitudinal basket ribs are shown in this embodiment for illustrative purposes.

In this embodiment, strainer basket 130 includes a basket mesh 133, which has a desired mesh size. The mesh size is chosen to restrict the flow of portions of the undesirable material of the fluid to flow to electrode assembly 140f and conductive coil 120. The portions of the undesirable material of the fluid restricted from flowing to electrode assembly 140f and conductive coil 120 includes material of a predetermined size, wherein the predetermined size is larger than the mesh size. In this way, strainer basket 130 restricts the ability of portions of the undesirable material of the fluid to flow to electrode assembly 140f and conductive coil 120.

In this embodiment, basket mesh 133 extends between annular basket end cap 131a and annular basket ribs 131b, 131c, 131d and 131e, as well as between longitudinal basket ribs 132a, 132b, 132c and 132d. In this way, annular basket end cap 131a and annular basket ribs 131b, 131c, 131d and 131e and longitudinal basket ribs 132a, 132b, 132c and 132d provide support to basket mesh 133.

FIG. 10 is a schematic diagram of an ionization circuit 115a, which includes an electrode assembly. It should be noted that the schematic diagram of FIG. 10 illustrates the connections between the various components of ionization circuit 115a, and does not necessarily illustrate the relative positions of the various components of ionization circuit 115a. One embodiment of the arrangement of the components of an ionization circuit will be discussed in more detail below with FIGS. 11a-11n.

The electrode assembly of ionization circuit 115a can be of many different types, such as electrode assembly 140 of FIG. 1. Hence, in this embodiment, fastener 150 and electrode body 141 are in communication with each other as discussed in more detail above with FIG. 1. It should be noted that ionization circuit 115a can include a coated fastener, if desired.

In this embodiment, electrode assembly 140 includes electrode body 141 in communication with coil 120 (FIGS. 9a and 9b) through a fluid 118. Fluid 118 can be of many different types, such as water and oil. Fluid 118 generally includes the undesirable material that is discussed in more detail above. Conductive coil 120 is in communication with a solar panel array 112 through conductive line 168 (FIGS. 8b and 9a). In this embodiment, wire 168b of conductive line 168 is connected to conductive coil 120, as discussed in more detail above with FIG. 9a. It should be noted that wire 168b is also shown in FIG. 11n, which is discussed below.

In this embodiment, electrode assembly 140 includes fastener 150 in communication with solar panel array 112 through conductive line 167 (FIG. 9a). In this embodiment, solar panel array 112 is in communication with fastener 150 and conductive coil 120 through conductive lines 167 and 168 as shown in FIG. 9a. In some embodiments, fastener 150 is in communication with solar panel array 112 through an optional diode 119. It should be noted that, in some embodiments, diode 119 is included with solar panel array 112. In other embodiments, diode 119 is carried by purifier system housing 101.

In this embodiment, ionization circuit 115b includes an electronic indicator 177, which is connected between potentials V₁ and V₂. Electronic indicator 177 can be of many different types of indicators. For example, in some embodiments, electronic indicator 177 provides a visual indication that solar panel 112 is providing power. In particular, electronic indicator 177 provides the visual indication in response to solar panel 112 establishing potentials V₁ and V₂. The visual indication can be of many different types, such as a power bar which includes a plurality of light emitting diodes. One example of a power bar is shown in U.S. Pat. No. 5,589,764. In other embodiments, electronic indicator 177 operates as a power meter which numerically displays the amount of power being provided by solar panel 112. Electronic indicator 177 can be positioned at many different locations with a purifier system, several of which will be discussed in more detail below.

It should also be noted that ionization circuit 115a establishes a circuit path 116 through the connections between electrode body 141, fluid 118, coil 120, diode 119, solar panel array 112, fastener 150 and conductive lines 167 and 168. In particular, ionization circuit 115a establishes circuit path 116 through the connections between electrode body 141, fluid 118, coil 120, diode 119, solar panel array 112, fastener 150 and conductive lines 167 and 168.

Further, it should be noted that solar panel array 112 establishes potentials V₁ and V₂ of ionization circuit 115a to conductive lines 167 and 168, respectively. In this embodiment, solar panel array 112 establishes potential V₁ with fastener 150 through conductive line 167 and potential V₂ to coil 120 through conductive line 168. Solar panel array 112 established potentials V₁ and V₂ in response to receiving light 117. Light 117 can be of many different types, such as sunlight from a sun 127. It should be noted that, in this embodiment, potential V₁ is positive relative to potential V₂. In other embodiments, the various components of ionization circuit 115a can be connected together so that potential V₂ is positive relative to potential V₁.

Solar panel array 112 can be replaced with a power supply. The power supply can be of many different types, such as a battery, line voltage, and wind mill. In general, the power supply is capable of establishing potentials V₁ and V₂.

In operation, the potential difference between V₁ and V₂ drives current through circuit path 116. In particular, the potential difference between V₁ and V₂ drives the electrical current I through fluid 118, and fluid 118 is conditioned in response. Fluid 118 can be conditioned in many different ways, such as by ionizing the fluid and/or ionizing undesirable material of the fluid. The undesirable material of fluid 118 can be of many different types, such as algae, bacteria, and impurities. As discussed in more detail above, fastener 150 includes titanium and/or the titanium alloy to reduce the amount of corrosion experienced by fastener 150 in response to the flow of the electrical current I. It should be noted that, in this embodiment, the electrical current I flows through the titanium and/or titanium alloy of fastener 150 in response to solar panel array 112 receiving light 117.

FIGS. 11a and 11b are perspective and side views, respectively, of one embodiment of a purifier system 100. FIG. 11c is a cut-away perspective view of a purifier system housing of purifier system 100 taken along a cut-line 11c-11c of FIG. 11a, and FIGS. 11d and 11e are cut-away perspective and side views, respectively, of purifier system 100 taken along a cut-line 11d-11d of FIG. 11a. FIG. 11f is a top view of a portion of purifier system 100 of FIGS. 11a and 11b, and FIGS. 11g and 11h are perspective and side views, respectively, of the portion of purifier system 100 of FIG. 11f. FIGS. 11i and 11j are perspective and side views, respectively, of the portion of purifier system 100 of FIG. 11f with conductive coil 120 of FIG. 9b. FIG. 11k is a side perspective view of purifier system 100 of FIGS. 11a and 11b with the strainer basket 130 removed.

In this embodiment, purifier system 100 includes strainer assembly 169 of FIG. 9a, wherein strainer assembly 169 includes coil 120 of FIG. 9b and strainer basket 130 of FIG. 9c. It should be noted that strainer basket 130 is removed from strainer assembly 169 in FIGS. 11d, 11e, 11i and 11j so that coil 120 and/or electrode body 141 can be seen more clearly.

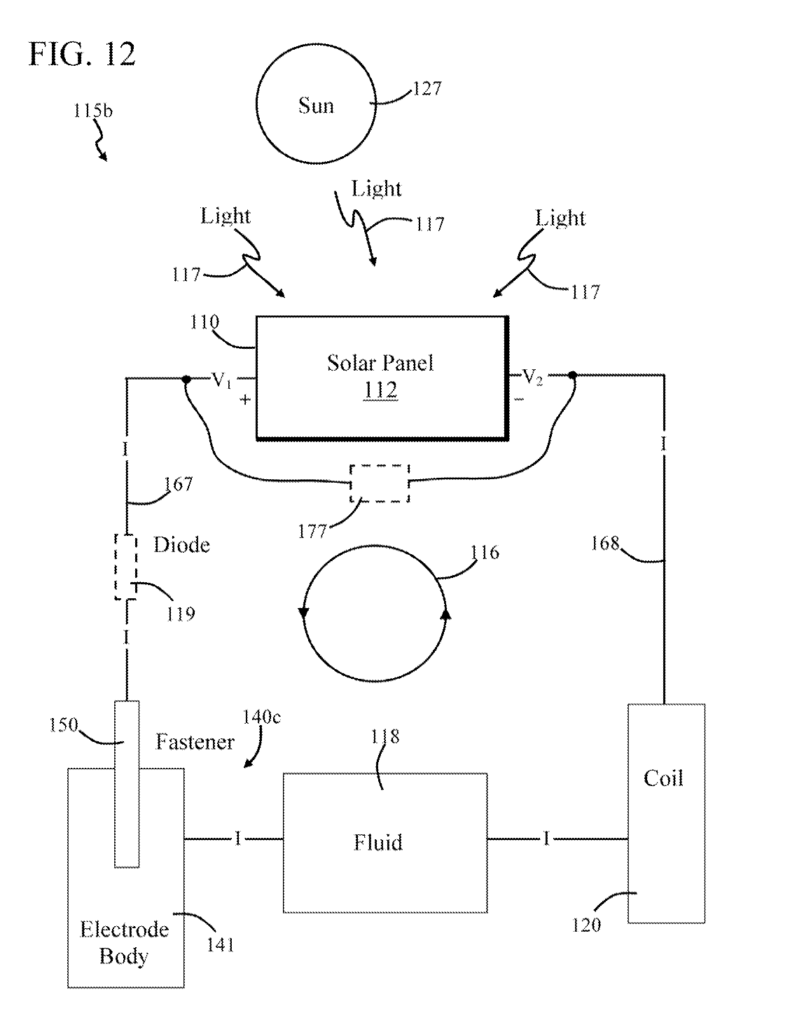

In this embodiment, purifier system 100 includes an ionization circuit 115b, which includes an electrode assembly, wherein ionization circuit 115b is shown in a schematic diagram in FIG. 12. It should be noted that the schematic diagram of FIG. 12 illustrates the connections between the various components of ionization circuit 115b, and does not necessarily illustrate the relative positions of the various components of ionization circuit 115b. One embodiment of the arrangement of the components of ionization circuit 115b is shown in FIGS. 11a-11i for illustrative purposes.

The electrode assembly of ionization circuit 115b can be of many different types, such as electrode assembly 140 of FIG. 1. Hence, in this embodiment, fastener 150 and electrode body 141 are in communication with each other as discussed in more detail above with FIG. 1. It should be noted that purifier system 100 can include a coated fastener, if desired.

Referring to FIGS. 11a, 11b, 11c, 11d, 11e, 11f, 11g, 11h, 11i and 11j, purifier system 100 includes a purifier system housing 101, which includes lower and upper purifier system housings 101a and 101b. It should be noted that, in some embodiments, upper and lower purifier system housings 101a and 101b are separate pieces coupled together. However, in this embodiment, upper and lower purifier system housings 101a and 101b are formed as a single integral piece. Upper and lower purifier system housings 101a and 101b can be formed as a single integral piece in many different ways, such as by using injection molding. Lower and upper purifier system housings 101a and 101b are sealed together so that purifier system housing 101 is buoyant. Lower purifier system housing 101a faces fluid 118 and upper purifier system housing 101b faces away from fluid 118. Purifier system housing 101 can include many different types of material, such as rubber and plastic.

Upper and lower purifier system housings 101a and 101b bound a housing cavity 101d, as shown in FIGS. 11c, 11d, 11e, 11g, 11b, 11i and 11j, wherein housing cavity 101d is an internal volume of purifier system housing 101. In this embodiment, purifier system 100 includes an annular flange 105 which extends annularly around the outer periphery of upper and lower purifier system housings 101a and 101b. Purifier system 100 includes a lower bumper ring 103 which extends annularly around flange 105. Lower bumper ring 103 protects purifier system housing 101 from damage, such as from engaging the side of a pool.

In this embodiment, purifier system 100 includes an annular groove 106 which extends annularly around an upper housing surface 102 of purifier system housing 101b. Purifier system 100 includes an upper bumper ring 104 which extends annularly around groove 106. Upper bumper ring 104 protects purifier system housing 101 from damage, such as from engaging a support surface when purifier system 100 is supported thereon upside down, such as during maintenance. Lower and upper seal rings 103 and 104 can include many different types of material, such as rubber and plastic.

In this embodiment, strainer assembly 169 is coupled to lower purifier system housing 101a so that strainer assembly 169 extends through fluid 118. Strainer assembly 169 can be coupled to lower purifier system housing 101a in many different ways. In this embodiment, strainer assembly 169 is slidingly engaged with housing central portion 101c of purifier system housing 101. Housing central portion 101c is also shown in FIGS. 8b and 9a. Strainer assembly 169 is slidingly engaged with housing central portion 101c so that is it repeatably moveable between coupled and uncoupled conditions with housing central portion 101c.

In this particular embodiment, fastener 151 is extended through electrical connector 178 and a housing central portion opening 179, wherein electrical connector 178 is electrically connected to conductive line 167, as shown in FIG. 8b. Conductive washer 164 is positioned at the same side of housing central portion 101c as electrical connector 178, and nut 165 is threaded to fastener 151 so that housing central portion 101c is held between nut 165 and washer 164. Insulative bushing 160 is positioned so that fastener 151 extends through insulative bushing channel 162. Electrode body 141 is positioned so that fastener 151 extends through electrode opening 142a. Conductive line 168 is electrically connected to conductive coil 120 using clamp 124, as discussed in more detail above. As shown in FIGS. 11i and 11j, conductive coil 120 is slidingly engaged with housing central portion 101c by sliding conductive coil 120 through a slot 123, which is shown in FIG. 11f, as well as some of the other drawings.

Strainer basket 130 is repeatably moveable between coupled and uncoupled conditions with housing central portion 101c. In this embodiment, strainer basket 130 is extended through an annular slot 126, which is shown in FIG. 11c, as well as some of the other drawings. Strainer basket 130 is held to electrode body 141 by insulative fastener 170, as discussed in more detail above with FIG. 9a.

In this embodiment, solar panel array 112 is carried by upper purifier system housing 101b proximate to upper housing surface 102, as shown in FIG. 11f. Solar panel array 112 includes a plurality of solar panels 113 operatively coupled together through a ribbon wire 111, which extends along upper housing surface 102. Conductive lines 167 and 168 are electrically connected to opposed terminals of ribbon wire 111. Solar panels 113 are operatively coupled together so they can establish the potential difference between potentials V₁ and V₂ in response to light 117 being received by solar panel array 112. As discussed in more detail herein, potentials V₁ and V₂ are applied to conductive lines 167 and 168, respectively. Conductive lines 167 and/or 168 are shown in FIGS. 8b, 9a, 10, 11i, 11j and 12. It should be noted that, in general, solar panel array 117 can include one or more solar panels. Further, it should be noted that solar panel array 112 is typically covered with a material which provides a hermetic seal. The material can be of many different types, such as a clear insulative coating. The material is clear to light 117 so that light 117 can flow therethrough and be received by solar panel array 112.

FIG. 11l is a top view of one embodiment of a solar panel array 112a, which can be included with purifier system 100 of FIGS. 11a and 11b, and FIGS. 11m and 11n are top and bottom perspective views, respectively, of solar panel array 112a of FIG. 11l. Solar panel array 112a can replace solar panel array 112 and upper bumper ring 104 of FIGS. 11a, 11b and 11k. Solar panel array 112a is useful because it can be manufactured as a separate piece and then positioned on upper housing surface 102, as shown in FIGS. 11c, 11d and 11e. In this way, solar panel array 112a can be removed front purifier system housing 101 and replaced with another one, if desired.

In this embodiment, solar panel array 112a includes a support substrate 108, which is disc shaped. Support substrate 108 can include many different types of material, such as rubber and plastic. In this embodiment, upper bumper ring 104 extends around the outer periphery of support substrate 108, and solar panels 113 and ribbon wire 111 are carried by support substrate 108. Upper bumper ring 104 is positioned proximate to upper housing surface 102 so that upper bumper ring 104 extends through annular groove 106 and support substrate 108 engages upper housing surface 102 (FIGS. 11c, 11d and 11e).

As shown in FIG. 11i, support substrate 108 includes openings 109a and 109b through which conductive lines 167 and 168, respectively, extend. As mentioned above, conductive lines 167 and 168 are electrically connected to oppose terminals of ribbon wire 111. In this embodiment, electrical connector 178 is connected to a distal end of conductive line 167. Distal end 168a of conductive line 168 is also shown in FIG. 11i. As mentioned with the discussion of FIG. 9a, distal end 168a is connected to coil 120.

FIG. 12 is a schematic diagram of an ionization circuit 115b, which includes an electrode assembly. It should be noted that the schematic diagram of FIG. 12 illustrates the connections between the various components of ionization circuit 115b, and does not necessarily illustrate the relative positions of the various components of ionization circuit 115b. The arrangement of the components of ionization circuit 115b corresponds to the embodiments of FIGS. 11a-11n.

The electrode assembly of ionization circuit 115b can be of many different types, such as electrode assembly 140 of FIG. 1. Hence, in this embodiment, fastener 150 and electrode body 141 are in communication with each other as discussed in more detail above with FIG. 1. It should be noted that ionization circuit 115b can include a coated fastener 150a, if desired.

In this embodiment, electrode assembly 140c includes electrode body 141 in communication with coil 120 (FIGS. 9a and 9b) through fluid 118. As mentioned above, fluid 118 can be of many different types, such as water and oil. Conductive coil 120 is in communication with a solar panel array 112 through conductive line 168 (FIGS. 8b and 9a). It should be noted that solar panel array 112 can be replaced with solar panel array 112a of FIGS. 11m and 11n. In this embodiment, wire 168b of conductive line 168 is connected to conductive coil 120, as discussed in more detail above with FIG. 9a. It should be noted that wire 168b is also shown in FIG. 11n, which is discussed above.

In this embodiment, electrode assembly 140c includes fastener 150 in communication with solar panel array 112 through conductive line 167 (FIG. 9a). In this embodiment, conductive line 167 is connected to fastener 150, as discussed in more detail above with FIG. 9a. Hence, solar panel array 112 is in communication with fastener 150 and coil 120 through conductive lines 167 and 168 as shown in FIG. 9a. In some embodiments, fastener 150 is in communication with solar panel array 112 through optional diode 119. It should be noted that, in some embodiments, diode 119 is included with solar panel array 112. In other embodiments, diode 119 is carried by purifier system housing 101.

In this embodiment, ionization circuit 115b includes electronic indicator 177, which is connected between potentials V₁ and V₂. As discussed above, electronic indicator 177 can be of many different types of indicators. For example, in some embodiments, electronic indicator 177 provides a visual indication that solar panel 112 is providing power. In particular, electronic indicator 177 provides the visual indication in response to solar panel 112 establishing potentials V₁ and V₂. The visual indication can be of many different types, such as a power bar which includes a plurality of light emitting diodes. One example of a power bar is shown in U.S. Pat. No. 5,589,764. In other embodiments, electronic indicator 177 operates as a power meter which numerically displays the amount of power being provided by solar panel 112. Electronic indicator 177 can be positioned at many different locations with a purifier system, several of which will be discussed in more detail below.

It should be noted that ionization circuit 115b establishes circuit path 116 through the connections between electrode body 141, fluid 118, coil 120, diode 119, solar panel array 112, fastener 150 and conductive lines 167 and 168. In particular, ionization circuit 115b establishes circuit path 116 through the connections between electrode body 141, fluid 118, coil 120, diode 119, solar panel array 112, fastener 150 and conductive lines 167 and 168.

Further, it should be noted that solar panel array 112 establishes potentials V₁ and V₂ of ionization circuit 115b to conductive lines 167 and 168, respectively. In this embodiment, solar panel array 112 establishes potential V₁ with fastener 150 through conductive line 167 and potential V₂ to coil 120 through conductive line 168. Solar panel array 112 established potentials V₁ and V₂ in response to receiving light 117. Light 117 can be of many different types, such as sunlight from sun 127. It should be noted that, in this embodiment, potential V₁ is positive relative to potential V₂. In other embodiments, the various components of ionization circuit 115b can be connected together so that potential V₂ is positive relative to potential V₁.

In operation, the potential difference between V₁ and V₂ drives current through circuit path 116. In particular, the potential difference between V₁ and V₂ drives the electrical current I through fluid 118, and fluid 118 is conditioned in response. Fluid 118 can be conditioned in many different ways, such as by ionizing the fluid and/or ionizing undesirable material of the fluid. The undesirable material of fluid 118 can be of many different types, such as algae, bacteria and impurities. As discussed in more detail above, fastener 150 includes titanium and/or the titanium alloy to reduce the amount of corrosion experienced by fastener 150 in response to the flow of the electrical current I. It should be noted that, in this embodiment, the electrical current I flows through the titanium and/or titanium alloy of fastener 150 in response to solar panel array 112 receiving light 117.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. An apparatus, comprising:
an electrode body, which operates as an anode;
an electrically conductive fastener includes titanium, wherein the electrically conductive fastener is engaged with the electrode body; and
a cathode spaced apart from the electrode body.

2. The apparatus of claim 1, wherein the electrically conductive fastener consists essentially of titanium.

3. The apparatus of claim 1, wherein the electrically conductive fastener extends into the electrode body.

4. The apparatus of claim 1, wherein the electrically conductive fastener and electrode both engage each other to establish an electrically conductive interface.

5. The apparatus of claim 1, wherein the electrode body has a cross-section which is one of circular, square, rectangular and triangular in shape.

6. An apparatus, comprising:
an electrically conductive fastener, which includes a corrosion resistant coating layer;
an electrode body, which operates as an anode, wherein the corrosion resistant coating layer is engaged with the electrode body; and
a cathode spaced apart from the electrode body.

7. The apparatus of claim 6, wherein the corrosion resistant coating layer is an electroplated layer.

8. The apparatus of claim 6, wherein the corrosion resistant coating layer includes titanium.

9. The apparatus of claim 6, wherein the corrosion resistant coating layer includes gold.

10. The apparatus of claim 6, wherein the corrosion resistant coating layer includes silver.

11. The apparatus of claim 6, wherein the corrosion resistant coating layer is proximate to the interface between the conductive fastener and electrode body.

12. The apparatus of claim 6, wherein the electrically conductive fastener includes one of Type 306 Stainless Steel and Type 316 Stainless Steel.

13. The apparatus of claim 6, wherein the electrically conductive fastener extends into the end of the electrode body, and the corrosion resistant coating layer is proximate to an interface between the electrically conductive fastener and electrode body.

14. An apparatus, comprising:
an electrically conductive fastener, which includes titanium;
an electrode assembly, which includes and an electrode body, wherein the electrically conductive fastener is engaged with the electrode body; and
a conductive coil through which the electrode body and electrically conductive fastener extend.

15. The apparatus of claim 14, wherein the electrically conductive fastener includes an electroplated titanium layer.

16. The apparatus of claim 14, wherein the electrically conductive fastener includes a titanium layer at the interface between the conductive fastener and electrode body.

17. The apparatus of claim 14, further including an electrically insulative bushing through which the electrically conductive fastener extends.

18. The apparatus of claim 14, further including an electrically insulative fastener engaged with the electrode body.

19. The apparatus of claim 18, wherein the electrically insulative fastener includes a shaft which is wider than a shaft of the electrically conductive fastener.

20. The apparatus of claim 14, further including a first electrical connector connected to the electrically conductive fastener and a second electrical connector connected to the conductive coil, and a power supply connected to the first and second connectors.
